(19) United States
(12) Patent Application Publication
(10) Pub. No.: US 2025/0299188 A1
(43) Pub. Date: Sep. 25, 2025

(54) ASSET UTILIZATION ACROSS ON-CHAIN AND OFF-CHAIN SYSTEMS

(71) Applicant: Unstoppable Domains, Inc., Las Vegas, NV (US)

(72) Inventors: Lisa Seacat DeLuca, Bozeman, MT (US); Matthew Gould, Atlanta, GA (US)

(21) Appl. No.: 18/609,377

(22) Filed: Mar. 19, 2024

(51) Int. Cl. G06Q 20/38; G06Q 20/36

(52) U.S. Cl. CPC G06Q 20/389; G06Q 20/36

(57) ABSTRACT

According to a present invention embodiment, a system for accessing an asset comprises one or more memories and at least one processor coupled to the one or more memories. The system acquires an asset identifier for one or more second systems based on a corresponding asset identifier for a first system. The corresponding asset identifier for the first system and the asset identifier for the one or more second systems are linked to enable access of an asset of the corresponding asset identifier on the first system using the asset identifier for the one or more second systems. Embodiments of the present invention further include a method and computer program product for accessing an asset of a system in substantially the same manner described above.

### TECHNICAL FIELD

Present invention embodiments relate to networks, and more specifically, to utilizing a name or other identifier of an asset of an on-chain or off-chain system for one or more assets of another on-chain or off-chain system. For example, a name or other identifier for an on-chain domain (e.g., Web3, blockchain, etc.) may be registered and utilized based on a name or other identifier for an off-chain domain (e.g., Web2, Domain Name System (DNS), etc.). Alternatively, a name or other identifier for an off-chain domain may be registered and utilized based on a name or other identifier for an on-chain domain. The on-chain and off-chain domain names may be linked to enable utilization of either name for accessing the corresponding domains (e.g., a Web2 domain may be used for transfer of cryptocurrency, etc.).

### BACKGROUND

### Discussion of the Related Art

Web2 generally refers to a version of the web (or Internet) that utilizes a Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

Web3 generally refers to a decentralized version of the web (or Internet) based on blockchains and peer-to-peer networks. However, there is generally no connection between an off-chain domain name (e.g., Web2, Domain Name System (DNS), etc.) and a corresponding on-chain domain name (e.g., Web3, blockchain, etc.). For example, an on-chain domain name and a corresponding off-chain domain name may be the same (except for the top level domain or extension), but registered to different users. This creates confusion and provides opportunities for malicious activity.

### SUMMARY

According to one embodiment of the present invention, a system for accessing an asset comprises one or more memories and at least one processor coupled to the one or more memories. The system acquires an asset identifier for one or more second systems based on a corresponding asset identifier for a first system. The corresponding asset identifier for the first system and the asset identifier for the one or more second systems are linked to enable access of an asset of the corresponding asset identifier on the first system using the asset identifier for the one or more second systems. Embodiments of the present invention further include a method and computer program product (e.g., including one or more computer readable media with instructions executable by one or more processors) for accessing an asset of a system in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of an example computing device according to an embodiment of the present invention.

FIG. 3 is a flowchart of a method of registering and utilizing a name or other identifier for an on-chain asset (e.g., Web3, blockchain, etc.) based on a name or other identifier for an off-chain asset (e.g., Web2, Domain Name System (DNS), etc.) according to an embodiment of the present invention.

FIG. 4 is flow diagram of a method of registering a name or other identifier for an on-chain asset (e.g., Web3, blockchain, etc.) based on a name or other identifier for an off-chain asset (e.g., Web2, Domain Name System (DNS), etc.) according to an embodiment of the present invention.

FIG. 5 is flow diagram of a method of registering a name for a Web3 or blockchain domain based on a name for a Web2 or Domain Name System (DNS) domain according to an embodiment of the present invention.

FIG. 6 is a flowchart of a method of registering and utilizing a name or other identifier for an off-chain asset (e.g., Web2, Domain Name System (DNS), etc.) based on a name or other identifier for an on-chain asset (e.g., Web3, blockchain, etc.) according to an embodiment of the present invention.

FIG. 7 is flow diagram of a method of registering a name or other identifier for an off-chain asset (e.g., Web2, Domain Name System (DNS), etc.) based on a name or other identifier for an on-chain asset (e.g., Web3, blockchain, etc.) according to an embodiment of the present invention.

FIG. 8 is a flowchart of a method of registering and utilizing a name or other identifier for an on-chain asset of a second system (e.g., Web3, blockchain, etc.) based on a name or other identifier for an on-chain asset of a different first system (e.g., Web3, blockchain, etc.) according to an embodiment of the present invention.

FIG. 9 is flow diagram of a method of registering a name or other identifier for an on-chain asset of a second system (e.g., Web3, blockchain, etc.) based on a name or other identifier for an on-chain asset of a different first system (e.g., Web3, blockchain, etc.) according to an embodiment of the present invention.

FIG. 10 is a flowchart of a method of registering and utilizing a name or other identifier for plural on-chain assets of different systems (e.g., Web3, blockchain, etc.) based on a name or other identifier of an off-chain asset (e.g., Web2, Domain Name System (DNS), etc.) according to an embodiment of the present invention.

FIG. 11 is flow diagram of a method of registering a name or other identifier for plural on-chain assets of different systems (e.g., Web3, blockchain, etc.) based on a name or other identifier of an off-chain asset (e.g., Web2, Domain Name System (DNS), etc.) according to an embodiment of the present invention.

FIG. 12 is a schematic illustration of an example graphical user interface presenting names available for on-chain domains (e.g., Web2, Domain Name System (DNS), etc.)) and off-chain domains (e.g., Web3, blockchain, etc.) according to an embodiment of the present invention.

FIG. 13A is a schematic illustration of an example graphical user interface providing registered domain names of a user according to an embodiment of the present invention.

FIG. 13B is a schematic illustration of an example graphical user interface indicating availability of names of on-chain domains (e.g., Web3, blockchain, etc.) for a registered off-chain domain name of a user (e.g., Web2, Domain Name System (DNS), etc.) according to an embodiment of the present invention.

### DETAILED DESCRIPTION

Web2 generally refers to a version of the web (or Internet) that utilizes a Domain Name System (DNS) to translate domain names into corresponding Internet Protocol (IP) addresses in order to access a web site. Domain Name System (DNS) creates a set of one or more records when a domain name is registered. DNS records (or text files) reside in DNS servers and provide information pertaining to a domain name including an associated IP address and request handling.

Web3 generally refers to a decentralized version of the web (or Internet) based on blockchains and peer-to-peer networks. However, there is generally no connection between an off-chain domain name (e.g., Web2, Domain Name System (DNS), etc.) and a corresponding on-chain domain name (e.g., Web3, blockchain, etc.). For example, an on-chain domain name and a corresponding off-chain domain name may be the same (except for the top level domain or extension), but registered to different users. This creates confusion and provides opportunities for malicious activity.

Accordingly, an embodiment of the present invention enables acquisition of a name or other identifier of an on-chain asset or an off-chain asset for on-chain and/or off-chain assets of other systems. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). An on-chain asset of a blockchain is preferably associated with a user wallet that is used to verify the user based on the user signing a message within the wallet using cryptographic keys. By way of example, the present invention embodiment may create an on-chain representation (e.g., Web3, blockchain, etc.) of an off-chain domain name (e.g., Web2, DNS, or other domain not residing on a blockchain, etc.) upon successful acquisition of the off-chain domain name.

Further, the present invention embodiment may automatically create and provide links between a name for an on-chain asset (e.g., Web3, blockchain, etc.) and a name of a corresponding off-chain asset (e.g., Web2, Domain Name System (DNS), etc.). For example, this may be accomplished by updating DNS records for a Web2 domain name and blockchain records for a Web3 domain name based on an association. In other words, the present invention embodiment updates records for on-chain and/or off-chain domain names based on an association between those domains. The linking between on-chain and off-chain domain names enables utilization of either name for accessing the corresponding domains (e.g., a Web2 domain may be used for transfer of cryptocurrency, etc.).

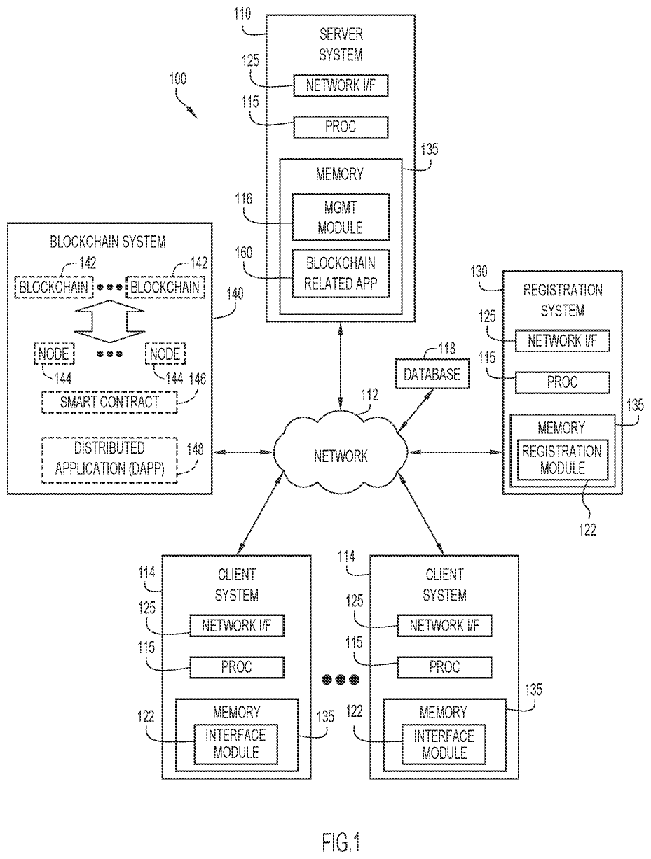

An example environment 100 for use with present invention embodiments is illustrated in FIG. 1. Specifically, environment 100 includes one or more server systems 110, one or more client or end-user systems 114, one or more registration systems 130, and one or more blockchain systems 140 each implementing and maintaining at least one corresponding blockchain 142. Server systems 110, client systems 114, registration systems 130, and/or blockchain systems 140 may be remote from each other and communicate over a network 112. The network may be implemented by any number of any suitable communications media (e.g., wide area network (WAN), local area network (LAN), Internet, Intranet, etc.). Alternatively, server systems 110, client systems 114, registration systems 130, and/or blockchain systems 140 may be local to each other, and communicate via any appropriate local communication medium (e.g., local area network (LAN), hardwire, wireless link, Intranet, etc.).

Server systems 110 include a management module 116. Management module 116 may interface with a user via client system 114, and/or may be of the form of an Application Programming Interface (API) to perform on-chain and/or off-chain asset management (e.g., for domains or other objects, etc.). The management module may process requests from any entities (e.g., user, application, service, computing or other device, etc.).

Client systems 114 may include an interface module 122 to provide a graphical user (e.g., GUI, etc.) or other interface (e.g., command line prompts, menu screens, etc.) that enables users to access server systems 110 for managing on-chain and/or off-chain assets (e.g., domains or other objects, etc.). The interface module may include any conventional or other browser to access server systems 110.

Registration systems 130 include a registration module 132 that registers names or other identifiers for off-chain assets (e.g., Web2, Domain Name System (DNS), etc.). By way of example, the registration system may include a conventional or other DNS server.

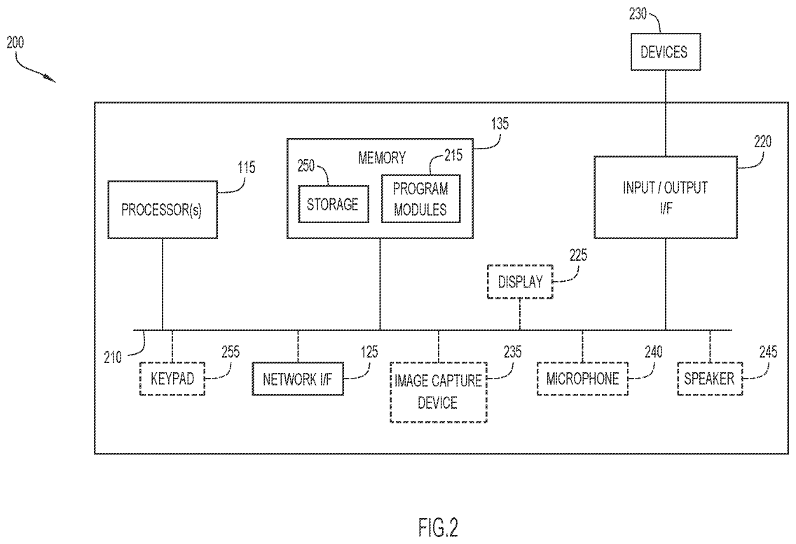

Blockchain systems 140 may each include one or more nodes 144 to implement and maintain at least one corresponding blockchain 142. The nodes may be implemented by any suitable computing devices (e.g., as described below for FIG. 2). The blockchain is generally in the form of a ledger that includes a series of records or blocks chained or linked together. The blockchain is typically managed by a peer-to-peer network (of nodes 144) and used as a distributed ledger. Nodes 144 of the peer-to-peer network communicate and verify new blocks according to a protocol. The peer-to-peer network provides a decentralized approach, where each node has a copy of a blockchain 142. Transactions are transmitted to the peer-to-peer network, where mining nodes (nodes 144) process the transactions. The mining nodes validate a transaction, insert the transaction into a current block, and transmit the block to the other nodes. Blockchain 142 may be implemented by any conventional or other blockchain, and may be a public (e.g., no access restrictions, etc.), private (e.g., restricted access, etc.), or hybrid (e.g., with centralized and decentralized features) blockchain.

Blockchain systems 140 may include one or more distributed or decentralized applications (dApps) 148 to perform various operations (e.g., financial or other transactions or operations related to a blockchain, etc.). In addition, a blockchain 142 may store software (e.g., typically referred to as smart contracts 146) that executes on the blockchain in response to occurrence of pre-defined conditions. The on-chain assets may be associated with the same and/or various different blockchains.

Interface module 122 of client systems 114 may further provide a graphical user (e.g., GUI, etc.) or other interface (e.g., command line prompts, menu screens, etc.) that enables users to access distributed applications (dApps) 148 on blockchain systems 140 for performing various operations (e.g., financial or other transactions or operations related to a blockchain, etc.). The interface module may include any conventional or other browser to access the distributed applications (dApps) of blockchain systems 140. The interface module may natively, or include extensions to, access the distributed applications (dApps). The interface module may provide a user interface to serve as a front end for a distributed application (dApp) 148, where back end processing for the distributed application (dApp) is performed on a blockchain system 140. Client systems 114 may further provide reports or notifications pertaining to requests from users (e.g., results of an access request, verification results, etc.).

Server systems 110 further include one or more blockchain related applications 160 for performing various operations (e.g., transactions or operations related to a blockchain, access asset information based on an associated asset, etc.). Management module 116 and blockchain related applications 160 may be on the same or different server systems 110. The blockchain related application may process requests from any entities (e.g., user, application, service, computing or other device, etc.).

A database or off-chain storage system 118 may store various information for an asset (e.g., asset information, mappings of assets to blockchains, etc.). The database system may be implemented by any conventional or other database or storage unit (e.g., Interplanetary File System (IPFS), etc.), may be local to or remote from server systems 110, client systems 114, registration systems 130, and/or blockchain systems 140, and may communicate via any appropriate communication medium (e.g., local area network (LAN), wide area network (WAN), Internet, hardwire, wireless link, Intranet, etc.).

Server systems 110, client systems 114, and registration systems 130 may be implemented by any conventional or other computer systems preferably equipped with a display or monitor, a base, optional input devices (e.g., a keyboard, mouse or other input device), and any software for use by present invention embodiments (e.g., server/communications software, blockchain software, management module 116, interface module 122, registration module 132, blockchain related applications 160, etc.). The base may include at least one hardware processor 115 (e.g., microprocessor, controller, central processing unit (CPU), etc.), one or more memories 135, and/or internal or external network interfaces or communications devices 125 (e.g., modem, network cards, etc.)).

Management module 116, interface module 122, registration module 132, smart contracts 146, distributed applications (dApps) 148, and blockchain related applications 160 may include one or more modules or units to perform the various functions of present invention embodiments described below. The various modules (e.g., management module 116, interface module 122, registration module 132, blockchain related applications 160, etc.) may be implemented by any combination of any quantity of software and/or hardware modules or units, and may reside within memory 135 of the server and/or client systems for execution by a corresponding processor 115. The various modules of the blockchain (e.g., smart contracts 146, distributed applications (dApps) 148, etc.) may be implemented by any combination of any quantity of software and/or hardware modules or units, and may reside on a blockchain 142 for execution by one or more nodes 144.

An example of a computing device 200 for environment 100 (e.g., implementing server systems 110, client systems 114, registration systems 130, blockchain systems 140, nodes 144, etc.) is illustrated in FIG. 2. The example computing device may perform the functions of present invention embodiments described herein. Computing device 200 may be implemented by any personal or other type of computer or processing system (e.g., desktop, laptop, hand-held device, smartphone or other mobile device, etc.), and may be used for any computing environments (e.g., cloud computing, client-server, network computing, mainframe, stand-alone systems, etc.).

Computing device 200 may include one or more processors 115 (e.g., microprocessor, controller, central processing unit (CPU), etc.), network interface 125, memory 135, a bus 210, and an Input/Output interface 220. Bus 210 couples these components for communication, and may be of any type of bus structure, including a memory bus or memory controller, a peripheral bus, and a processor or local bus using any of a variety of conventional or other bus architectures. Memory 135 is coupled to bus 210 and typically includes computer readable media including volatile media (e.g., random access memory (RAM), cache memory, etc.), non-volatile media, removable media, and/or non-removable media. For example, memory 135 may include storage 250 containing nonremovable, non-volatile magnetic or other media (e.g., a hard drive, etc.). The computing device may further include a magnetic disk drive and/or an optical disk drive (not shown) (e.g., CD-ROM, DVD-ROM or other optical media, etc.) connected to bus 210 via one or more data interfaces.

Moreover, memory 135 includes a set of program modules 215 (e.g., corresponding to management module 116, interface module 122, registration module 132, blockchain software (e.g., smart contracts 146, distributed applications (dApp) 148, blockchain management software, etc.), blockchain related applications 160, network site or service software, etc.) that are configured to perform functions of present invention embodiments described herein. The memory may further include an operating system, at least one application and/or other modules, and corresponding data. These may provide an implementation of a networking environment.

Input/Output interface 220 is coupled to bus 210 and communicates with one or more peripheral or external devices 230 (e.g., a keyboard, mouse or other pointing device, a display, sensing devices, etc.), at least one device that enables a user to interact with computing device 200, and/or any device (e.g., network card, modem, etc.) that enables computing device 200 to communicate with one or more other computing devices. Computing device 200 may communicate with one or more networks (e.g., a local area network (LAN), a wide area network (WAN), a public network (e.g., the Internet), etc.) via network interface 125 coupled to bus 210.

With respect to certain entities (e.g., client system 114, etc.), computing device 200 may further include, or be coupled to, a touch screen or other display 225, a camera or other image capture device 235, a microphone or other sound sensing device 240, a speaker 245 to convey sound, and/or a keypad or keyboard 255 to enter information (e.g., alphanumeric information, etc.). These items may be coupled to bus 210 or Input/Output interface 220 to transfer data with other elements of computing device 200.

Initially, a blockchain (e.g., blockchain 142, etc.) is generally in the form of a ledger that includes a series of records or blocks chained or linked together. Each block includes a hash of the prior block in the blockchain, a timestamp, and transaction information. The hash of the prior block enables the blockchain to be resistant to modification since changes to data in any prior block alter the hash value which propagates to subsequent blocks.

A blockchain is typically managed by a peer-to-peer network and used as a distributed ledger. Nodes of the peer-to-peer network communicate and verify new blocks according to a protocol. The peer-to-peer network provides a decentralized approach, where each node has a copy of the blockchain. Transactions are transmitted to the network, where mining nodes process the transactions. The mining nodes validate a transaction, insert the transaction into a current block, and transmit the block to the other nodes. Various consensus approaches may be used for combining validation results of different mining nodes to determine validity of a transaction (or block).

Users of transactions for the blockchain are authenticated based on cryptographic keys. These keys identify a user and provide access to a user account or wallet. The user wallet is basically an application or software that enables users to store and access digital assets (e.g., for receiving or sending cryptocurrency or other fungible tokens, non-fungible tokens (NFTs), etc.). For example, a non-fungible token (NFT) is a crypto type asset with each token being unique (and representing items, such as digital art, music, or video game items), whereas fungible tokens (e.g., coins of the same cryptocurrency) have the same value of worth and are exchangeable. Each user is associated with their own private key (e.g., accessible only to the associated user, etc.) and a public key (e.g., typically an address on the blockchain). The private and public keys enable authentication of the user based on digital signatures in order to commence a transaction. The user account or wallet typically stores the private key.

For example, in order for the user to send cryptocurrency, a message for a transaction is encrypted (or signed) with the private key of the user wallet. The private key enables only the user to control the user wallet. A digital signature is created by encrypting the message with the private key, where the digital signature is used to verify the user and transaction. The message may be decrypted with the corresponding public key of the user wallet. Since the private key is unique to the user, successful decryption of the message with the corresponding public key verifies the message was sent by the user. Once verified, the transaction may be posted to the blockchain, thereby adjusting the user wallet based on the transaction.

In addition, a blockchain may store software (e.g., typically referred to as smart contracts) that executes in response to occurrence of pre-defined conditions. A smart contract 146 is generally software or a program that runs on the blockchain. The code and data for the smart contract reside at a specific address on the blockchain. Non-fungible tokens (NFTs) are controlled by smart contracts that handle transference and verification of ownership of the non-fungible tokens (NFTs). A blockchain may be public (e.g., no access restrictions, etc.), private (e.g., restricted access, etc.), or hybrid (e.g., with centralized and decentralized features).

A blockchain domain name is stored on a blockchain. The blockchain domain name may be a non-fungible token (NFT) domain name that is associated with a non-fungible token (NFT) stored in a user wallet. The blockchain domain name may be associated with various information (e.g., wallet addresses, user information (e.g., name, address, email, etc.), data or other access restrictions, etc.). The blockchain domain name is associated with software or smart contracts on the blockchain that may perform various functions (e.g., provide a registry for corresponding wallet addresses, indicate locations of content for the domain (e.g., or a website, etc.) hosted on the blockchain or other system, etc.). In order to access a blockchain domain, the blockchain is accessed to find the record corresponding to the blockchain domain name (which may initiate the corresponding smart contracts for the corresponding functionality). The private key of the user wallet enables the user to have sole control of the blockchain domain name (e.g., authenticating operations or transactions for the blockchain domain name similar to the cryptocurrency example described above, etc.). For example, the user may have sole control to perform operations that alter content and/or functionality for the blockchain domain name.

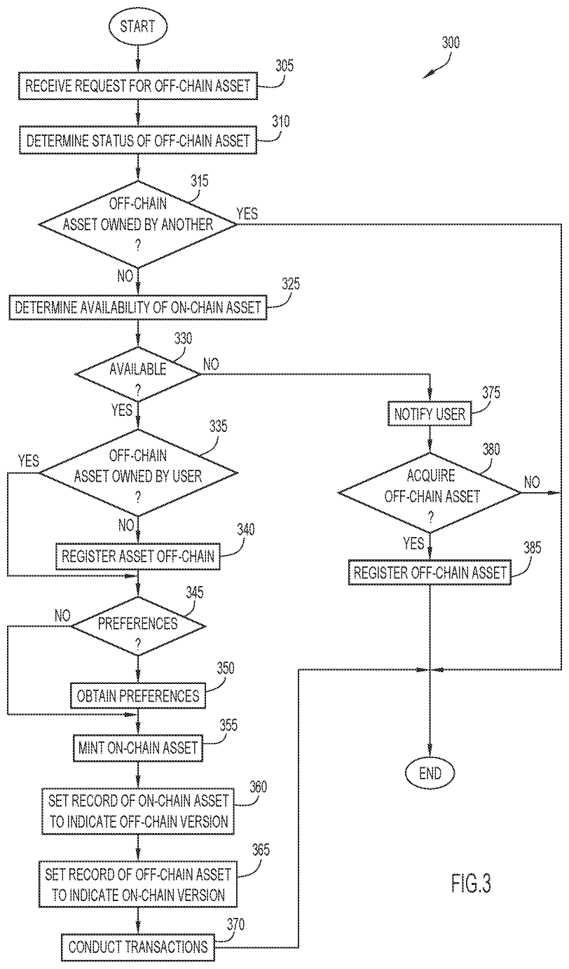

A method 300 of registering and utilizing a name or other identifier for an on-chain asset (e.g., Web3, blockchain, etc.) based on a name or other identifier for an off-chain asset (e.g., Web2, Domain Name System (DNS), etc.) (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 3. Initially, a user may register, or desire to register, a name or other identifier for an off-chain asset (e.g., Web2, Domain Name System (DNS), etc.) via management module 116 of server system 110. The user may further desire to register the name or other identifier of the off-chain asset for an on-chain asset (e.g., Web3, blockchain and/or smart contract, etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the off-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the off-chain asset at operation 305. The management module performs a look-up of the name of the off-chain asset at operation 310 to determine registration/ownership of the off-chain asset by another user (e.g., indicating unavailability of the off-chain asset). By way of example, the off-chain asset may include an off-chain domain name (e.g., Web2, Domain Name System (DNS), etc.), and management module 116 requests information (e.g., DNS records, etc.) for the off-chain domain name from registration system 130. The information from the registration system indicates registration/ownership or availability of the off-chain asset.

When the off-chain asset is not registered/owned by another user as determined at operation 315, management module 116 determines availability of the name of the off-chain asset for an on-chain asset at operation 325. In other words, management module determines availability of an on-chain equivalent of the off-chain asset. For example, the management module (e.g., via blockchain related application 160) accesses an intended blockchain 142 for the on-chain version (e.g., via a blockchain system 140), and performs a look-up for the name of the off-chain asset on the blockchain. Absence of a record on the blockchain for the name indicates the name for the off-chain asset (or on-chain version) is available on the blockchain. The intended blockchain may be selected by a user, and the name for the look-up may include the name portion of the name of the off-chain asset (e.g., with the same extension, a corresponding extension for the intended blockchain, etc.).

When an on-chain representation of the off-chain asset is available as determined at operation 330, the name for the off-chain asset is registered off-chain at operation 340 when the name for the off-chain asset is available (and not registered/owned by the user) as determined at operation 335. In this case, management module 116 (e.g., via registration module 132 of registration system 130) registers the name of the off-chain asset to the user. By way of example, registration module 132 creates a set of one or more (e.g., Domain Name System (DNS)) records containing access and other information when an off-chain domain name is registered. For example, the records may include records of one or more record types including an address (or A) record, a hostname pointing (or canonical name (CNAME) alias) record, a mail (or MX) record, a name server (or NS) record, a private name server record, a start of authority (or SOA) record, a text (or TXT/SPF) record, and a service (or SRV) record.

Payment and other preferences may be provided or selected for acquiring (or minting) the on-chain version. The options or preferences may include payment to acquire the on-chain representation, an intended blockchain or other system to mint the on-chain version, a smart contract for the transaction, etc. When preferences are required as determined at operation 345, management module 116 obtains the preferences at operation 350. For example, the preferences may be stored off-chain in database system 118, or received from an administrator.

The name for the on-chain version is acquired at operation 355. For example, management module 116 (e.g., via blockchain related application 160, corresponding smart contract 146, and/or distributed application (dApp) 148) mints (or publishes) the name for the on-chain version on a corresponding blockchain. The minting may be performed based on any required preferences. This may be accomplished by management module 116 (e.g., via blockchain related application 160, corresponding smart contract 146, and/or distributed application (dApp) 148) providing a transaction to the blockchain indicating ownership of the on-chain version by the user. In addition, various information for the on-chain version (e.g., user information, asset information, wallet information, etc.) may be stored on-chain and/or in off-chain storage (e.g., database system 118, etc.).

In order to link the off-chain and on-chain versions, management module 116 (e.g., via distributed application (dApp) 148 and/or blockchain related application 160) sets a record associated with the on-chain asset to indicate the off-chain asset at operation 360. For example, an on-chain or off-chain record may be created or modified to include an identifier for the off-chain asset (e.g., an off-chain domain name to be linked, etc.).

In addition, management module 116 (e.g., via registration module 132 of registration system 130) sets a record associated with the off-chain asset to indicate the on-chain representation at operation 365. For example, a Domain Name System (DNS) canonical name or other record may be created or modified to include an identifier for the on-chain asset (e.g., on-chain domain name, wallet address, etc.).

Once the records linking the on-chain and off-chain representations are processed, transactions are conducted (e.g., via management module 116 and/or blockchain related application 160) at operation 370 using the names for the on-chain or off-chain assets. For example, the information in the record for the off-chain asset may be used to resolve data for the on-chain representation (e.g., a user may send cryptocurrency to an off-chain asset (based on an associated record indicating the on-chain asset), etc.). The transaction may be analyzed to determine the actions, underlying system, and the corresponding representation needed for that system. By way of example, when the transaction is for an on-chain representation (or domain) for an on-chain system using an off-chain representation (or domain), a lookup of the Domain Name System (DNS) canonical name or other record associated with the off-chain representation (e.g., web2/off-chain/DNS version of the on-chain domain) is performed to obtain the on-chain representation for conducting the transaction. A similar approach may be used for off-chain transactions using on-chain representations. Further, transactions conducted for an on-chain or off-chain representation may automatically be applied to the linked (off-chain or on-chain) representation based on the linking information. By way of example, selling an off-chain representation also sells the linked on-chain representation (and vice versa), transferring the on-chain representation also transfers the linked off-chain representation (and vice versa), making available for auction the on-chain representation also makes the linked off-chain representation available (and vice versa), purchasing an off-chain representation brand new also purchases the linked on-chain representation (and vice versa), taking out a loan may apply to the linked representations or be conducted using one of the linked representations, extending expiration of (or renewing) an off-chain representation extends (or renews) the registration for a linked on-chain representation (and vice versa), and/or transferring an off-chain domain to a new registrar (in the case of domains) transfers the on-chain domain to the new registrar (or vice versa) or the transfer may be conducted using one of the linked representations.

When the name of the off-chain asset is not available based on the look-up (e.g., an on-chain representation of the off-chain asset is already present) as determined at operation 330, management module 116 alerts or notifies the user at operation 375. The notification may indicate ownership information for the on-chain version of the off-chain asset.

When the name of the off-chain asset is available for registration (e.g., not already registered/owned by the user), the user may still acquire the off-chain asset even though an on-chain version of the off-chain asset may be unavailable (e.g., due to the existence of a conflicting on-chain asset, etc.). In this case, management module 116 may request an indication from the user to acquire the name for the off-chain asset. When the user desires to acquire the name for the off-chain asset (without the on-chain version) as determined at operation 380, management module 116 (e.g., via registration module 132 of registration system 130) registers the name of the off-chain asset to the user at operation 385. By way of example, registration module 132 creates a set of one or more (e.g., Domain Name System (DNS)) records when an off-chain domain name is registered in substantially the same manner described above.

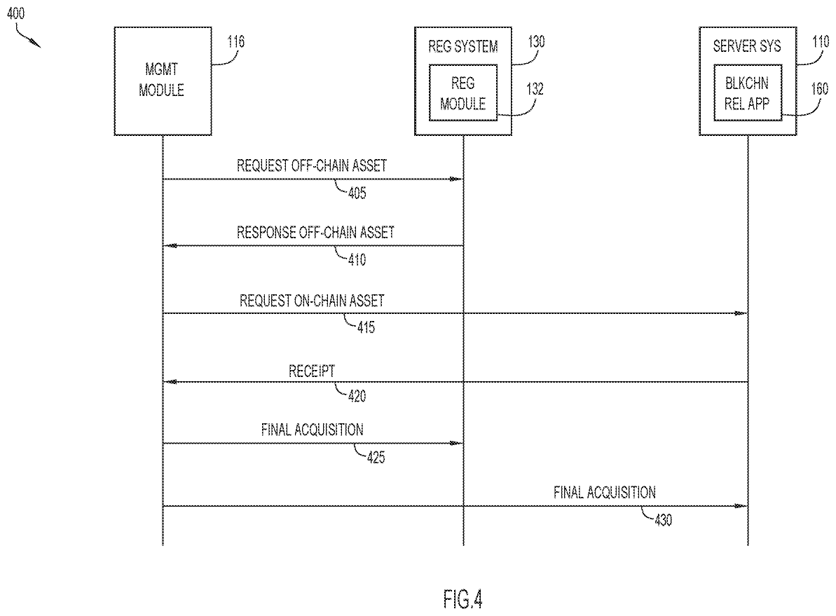

A method 400 of registering a name or other identifier for an on-chain asset (e.g., Web3, blockchain, etc.) based on a name or other identifier for an off-chain asset (e.g., Web2, Domain Name System (DNS), etc.) (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 4. Initially, a user may register, or desire to register, a name or other identifier for an off-chain asset (e.g., Web2, Domain Name System (DNS), etc.) via management module 116 of server system 110. The user may further desire to register the name or other identifier of the off-chain asset for an on-chain asset (e.g., Web3, blockchain and/or smart contract, etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the off-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the off-chain asset, and performs a look-up of the name of the off-chain asset to determine availability of the name of the off-chain asset for registration. Management module 116 requests information for the off-chain asset from registration module 132 of registration system 130 at flow 405. The registration module performs the look-up, and provides a response at flow 410 indicating availability of the off-chain asset.

When the off-chain asset is available for registration, management module 116 determines availability of the name of the off-chain asset for an on-chain asset. In other words, management module determines availability of an on-chain equivalent of the off-chain asset. The management module sends a request to blockchain related application 160 at flow 415 concerning the availability. The blockchain related application accesses an intended blockchain 142 for the on-chain version (e.g., via a blockchain system 140), and performs a look-up for the name of the off-chain asset on the blockchain. Absence of a record on the blockchain for the name indicates the name for the off-chain asset (or on-chain version) is available on the blockchain.

Blockchain related application 160 sends a response or receipt indicating availability of the on-chain asset to management module 116 at flow 420. Management module 116 directs registration module 132 of registration system 130 to register the name of the off-chain asset to the user at flow 425. In addition, the management module directs blockchain related application 160 to mint (or publish) the on-chain asset at flow 430. In this case, blockchain related application 160 (e.g., via a corresponding smart contract 146 and/or distributed application (dApp) 148) mints (or publishes) the name for the on-chain version on a corresponding blockchain. This may be accomplished by blockchain related application 160 (e.g., via corresponding smart contract 146 and/or distributed application (dApp) 148) providing a transaction to the blockchain indicating ownership of the on-chain version by the user. In addition, various information for the on-chain version (e.g., user information, asset information, wallet information, etc.) may be stored on-chain and/or in off-chain storage (e.g., database system 118, etc.).

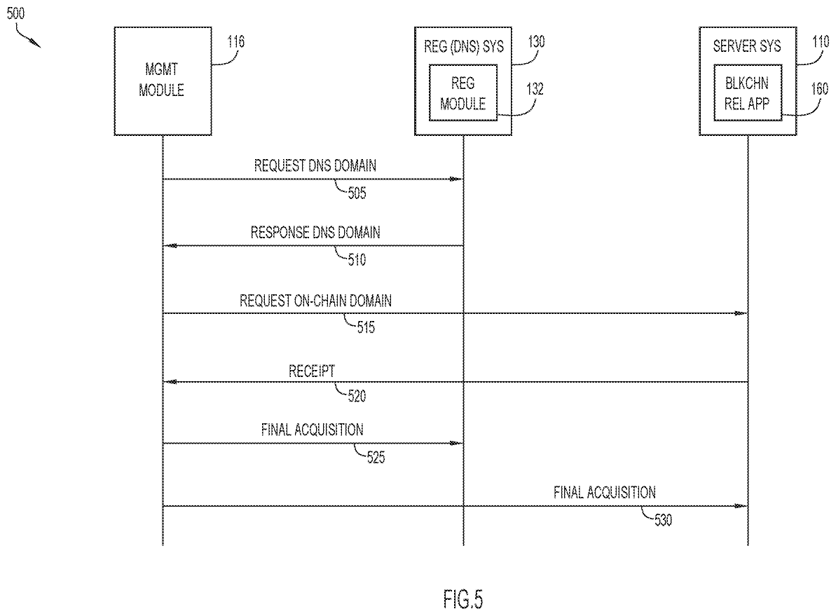

A method 500 of registering a name for a Web3 or blockchain domain based on a name for a Web2 or Domain Name System (DNS) domain (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 5. Initially, a user may register, or desire to register, a name or other identifier for a DNS domain via management module 116 of server system 110. The user may further desire to register the DNS name for an on-chain domain (e.g., Web3, blockchain and/or smart contract, etc.). The name or other identifier for the DNS domain may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the DNS domain, and performs a look-up of the DNS domain name to determine availability of the DNS domain name for registration. Management module 116 requests information for the DNS domain name from registration module 132 of registration system 130 at flow 505. By way of example, registration system 130 may include a conventional or other DNS server. The registration module performs the look-up, and provides a response at flow 510 indicating availability of the DNS domain name.

When the DNS domain name is available for registration, management module 116 determines availability of the DNS domain name for an on-chain domain. In other words, management module determines availability of an on-chain equivalent of the DNS domain name. The management module sends a request to blockchain related application 160 at flow 515 concerning the availability. The blockchain related application accesses an intended blockchain 142 for the on-chain version (e.g., via a blockchain system 140), and performs a look-up for the DNS domain name on the blockchain. Absence of a record on the blockchain for the DNS domain name indicates the DNS domain name (or on-chain version) is available on the blockchain.

Blockchain related application 160 sends a response or receipt indicating availability of the on-chain domain name to management module 116 at flow 520. Management module 116 directs registration module 132 of registration system 130 to register the DNS domain name to the user at flow 525. In addition, the management module directs blockchain related application 160 to mint the on-chain domain name at flow 530. In this case, blockchain related application 160 (e.g., via corresponding smart contract 146 and/or distributed application (dApp) 148) mints (or publishes) the name for the on-chain version on a corresponding blockchain. This may be accomplished by blockchain related application 160 (e.g., via corresponding smart contract 146 and/or distributed application (dApp) 148) providing a transaction to the blockchain indicating ownership of the on-chain version by the user. In addition, various information for the on-chain version (e.g., user information, asset information, wallet information, etc.) may be stored on-chain and/or in off-chain storage (e.g., database system 118, etc.).

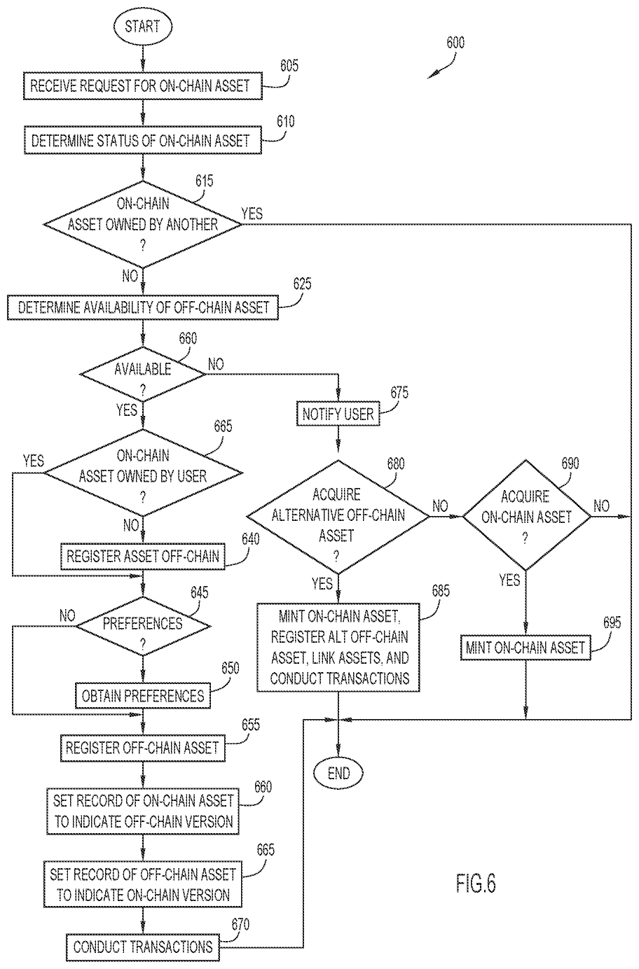

A method 600 of registering and utilizing a name or other identifier for an off-chain asset (e.g., Web3, Domain Name System (DNS), etc.) based on a name or other identifier for an on-chain asset (e.g., Web3, blockchain, etc.) (e.g., via management module 116, registration module 132, smart contract 146, distributed application (dApp) 148, blockchain related application 160, server system 110, client system 114, registration system 130, and/or blockchain system 140) according to an embodiment of the present invention is illustrated in FIG. 6. Initially, a user may register, or desire to register, a name or other identifier for an on-chain asset (e.g., Web3, blockchain, etc.) via management module 116 of server system 110. The user may further desire to register the name or other identifier of the on-chain asset for an off-chain asset (e.g., Web2, Domain Name System (DNS), etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the on-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the on-chain asset at operation 605. The management module performs a look-up of the name of the on-chain asset at operation 610 to determine registration/ownership of the on-chain asset by another user (e.g., indicating unavailability of the on-chain asset). By way of example, the on-chain asset may include an on-chain domain name (e.g., Web3, blockchain, etc.). In this case, the management module (e.g., via blockchain related application 160) accesses a corresponding blockchain 142 for the on-chain asset (e.g., via a blockchain system 140), and performs a look-up for the name of the on-chain asset on the blockchain. Absence of a record on the blockchain for the name indicates the name for the on-chain asset is available on the blockchain. The blockchain may be determined based on the extension of the name.

When the on-chain asset is not registered/owned by another user as determined at operation 615, management module 116 determines availability of the name of the on-chain asset for an off-chain asset at operation 625. In other words, management module 116 determines availability of an off-chain equivalent of the on-chain asset. For example, management module 116 requests information (e.g., DNS records, etc.) for the name of the on-chain asset name from registration system 130. The information from the registration system indicates registration/ownership or availability of the name of the on-chain asset.

When an off-chain representation of the on-chain asset is available as determined at operation 630, the name for the on-chain asset is registered on-chain at operation 640 when the name for the on-chain asset is available (and not registered/owned by the user) as determined at operation 635. For example, management module 116 (e.g., via blockchain related application 160, a corresponding smart contract 146, and/or distributed application (dApp) 148) mints (or publishes) the name for the on-chain asset on a corresponding blockchain. The minting may be performed based on any required preferences as described above. This may be accomplished by management module 116 (e.g., via blockchain related application 160, a corresponding smart contract 146, and/or distributed application (dApp) 148) providing a transaction to the blockchain indicating ownership of the on-chain asset by the user. In addition, various information for the on-chain asset (e.g., user information, asset information, wallet information, etc.) may be stored on-chain and/or in off-chain storage (e.g., database system 118, etc.).

Payment and other preferences may be provided or selected for acquiring (or registering) the off-chain version. The options or preferences may include payment to acquire the off-chain representation, a time period for the registration (e.g., months, years, etc.), etc. When preferences are required as determined at operation 645, management module 116 obtains the preferences at operation 650. For example, the preferences may be stored in database system 118, or received from an administrator.

The name for the off-chain version is acquired at operation 655. In this case, management module 116 (e.g., via registration module 132 of registration system 130) registers the name of the off-chain asset to the user. By way of example, registration module 132 creates a set of one or more (e.g., Domain Name System (DNS)) records containing access and other information when an off-chain domain name is registered. For example, the records may include records of one or more record types including an address (or A) record, a hostname pointing (or canonical name (CNAME) alias) record, a mail (or MX) record, a name server (or NS) record, a private name server record, a start of authority (or SOA) record, a text (or TXT/SPF) record, and a service (or SRV) record.

In order to link the on-chain and off-chain versions, management module 116 (e.g., via a corresponding smart contract 146, distributed application (dApp) 148, and/or blockchain related application 160) sets a record associated with the on-chain asset to indicate the off-chain asset at operation 660. For example, an on-chain or off-chain record may be created or modified to include an identifier for the off-chain asset (e.g., an off-chain domain name to be linked, etc.).

In addition, management module 116 (e.g., via registration module 132 of registration system 130) sets a record associated with the off-chain asset to indicate the on-chain representation at operation 665. For example, a Domain Name System (DNS) canonical name or other record may be created or modified to include an identifier for the on-chain asset (e.g., on-chain domain name, wallet address, etc.).

Once the records linking the on-chain and off-chain representations are processed, transactions are conducted (e.g., via management module 116 and/or blockchain related application 160) at operation 670 using the names for the on-chain or off-chain assets. For example, the information in the record for the off-chain asset may be used to resolve data for the on-chain asset (e.g., a user may send cryptocurrency to an off-chain asset (based on an associated record indicating the on-chain asset), etc.). The transaction may be analyzed to determine the actions, underlying system, and the corresponding representation needed for that system. By way of example, when the transaction is for an on-chain representation (or domain) for an on-chain system using an off-chain representation (or domain), a lookup of the Domain Name System (DNS) canonical name or other record associated with the off-chain representation (e.g., web2/off-chain/DNS version of the on-chain domain) is performed to obtain the on-chain representation for conducting the transaction. A similar approach may be used for off-chain transactions using on-chain representations. Further, transactions conducted for an on-chain or off-chain representation may automatically be applied to the linked (off-chain or on-chain) representation based on the linking information. By way of example, selling an off-chain representation also sells the linked on-chain representation (and vice versa), transferring the on-chain representation also transfers the linked off-chain representation (and vice versa), making available for auction the on-chain representation also makes the linked off-chain representation available (and vice versa), purchasing an off-chain representation brand new also purchases the linked on-chain representation (and vice versa), taking out a loan may apply to the linked representations or be conducted using one of the linked representations, extending expiration of (or renewing) an off-chain representation extends (or renews) the registration for a linked on-chain representation (and vice versa), and/or transferring an off-chain domain to a new registrar (in the case of domains) transfers the linked on-chain domain to the new registrar (or vice versa) or the transfer may be conducted using one of the linked representations.

When the name of the on-chain asset is not available off-chain based on the look-up (e.g., an off-chain representation of the on-chain asset is already present) as determined at operation 630, management module 116 alerts or notifies the user at operation 675. The notification may indicate ownership information for the off-chain version of the on-chain asset, and/or expiration information for the off-chain asset. In addition, management module 116 may determine an alternative name that is available off-chain and partially matches the name for the on-chain asset (e.g., the alternative name may include the same name portion with a different extension, a numerical or other sequence appended to the name portion, etc.). Management module 116 may perform a look-up (e.g., via registration module 132) to determine and/or confirm availability of the alternative name based on registration information of registration system 130.

Management module 116 may present the alternative name and request an indication from the user to acquire the alternative name for the off-chain asset. When the user desires to acquire the alternative name for the off-chain asset as determined at operation 680, the management module registers the name of the on-chain asset (when not owned by the user), registers the alternative name for the off-chain asset, links the on-chain and off-chain assets, and conducts transactions at operation 685 in substantially the same manner described above (e.g., for operations 635-670).

When the name of the on-chain asset is available for registration (e.g., not already registered/owned by the user), the user may still acquire the on-chain asset even though an off-chain version of the on-chain asset may be unavailable (e.g., due to the existence of a conflicting off-chain asset, etc.). In this case, management module 116 may request an indication from the user to acquire the name for the on-chain asset. When the user desires to acquire the name for the on-chain asset (without the off-chain version) as determined at operation 690, management module 116 (e.g., via blockchain related application 160, a corresponding smart contract 146, and/or distributed application (dApp) 148) registers the name of the on-chain asset to the user at operation 695. By way of example, management module 116 (e.g., via blockchain related application 160, a corresponding smart contract 146, and/or distributed application (dApp) 148) may provide a transaction to the blockchain indicating ownership of the on-chain asset by the user in substantially the same manner described above. In addition, various information for the on-chain asset (e.g., user information, asset information, wallet information, etc.) may be stored on-chain and/or in off-chain storage (e.g., database system 118, etc.) in substantially the same manner described above.

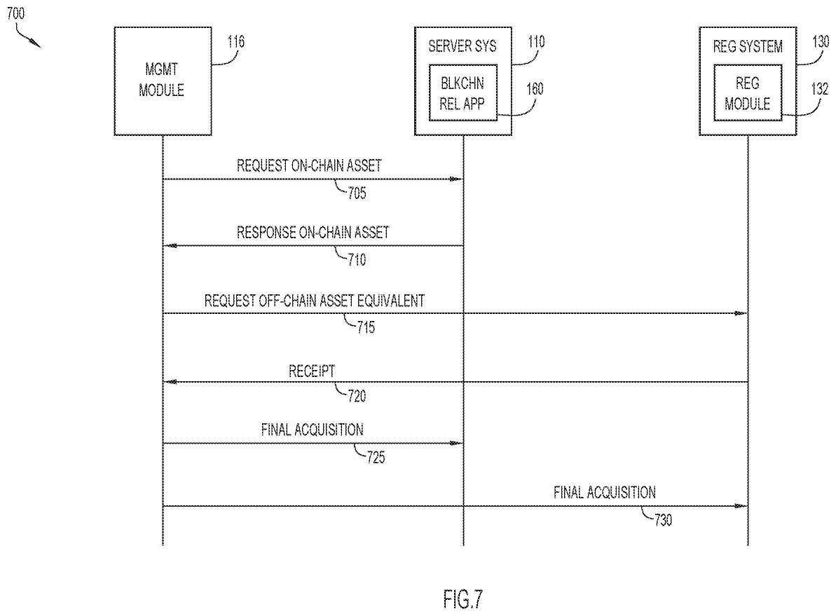

A method 700 of registering a name or other identifier for an off-chain asset (e.g., Web2, Domain Name System (DNS), etc.) based on a name or other identifier for an on-chain asset (e.g., Web3, blockchain, etc.) according to an embodiment of the present invention is illustrated in FIG. 7. Initially, a user may register, or desire to register, a name or other identifier for an on-chain asset (e.g., Web3, blockchain, etc.) via management module 116 of server system 110. The user may further desire to register the name or other identifier of the on-chain asset for an off-chain asset (e.g., Web2, Domain Name System (DNS), etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the on-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the on-chain asset, and performs a look-up of the name of the on-chain asset to determine availability of the name of the on-chain asset for registration. The management module sends a request to blockchain related application 160 at flow 705 concerning the availability. The blockchain related application accesses an intended blockchain 142 for the on-chain version (e.g., via a blockchain system 140), and performs a look-up for the name of the on-chain asset on the blockchain. Absence of a record on the blockchain for the name indicates the name for the on-chain asset is available on the blockchain. Blockchain related application 160 sends a response indicating availability of the on-chain asset to management module 116 at flow 710.

When the on-chain asset is available for registration, management module 116 determines availability of the name of the on-chain asset for the off-chain asset. In other words, management module determines availability of an off-chain equivalent of the on-chain asset. Management module 116 requests information for the off-chain asset corresponding to the name of the on-chain asset from registration module 132 of registration system 130 at flow 715. The registration module performs the look-up, and provides a response at flow 720 indicating availability of the off-chain asset.

Management module 116 directs blockchain related application 160 to mint (or publish) the on-chain asset at flow 725. In this case, blockchain related application 160 (e.g., via a corresponding smart contract 146 and/or distributed application (dApp) 148) mints (or publishes) the name for the on-chain version on a corresponding blockchain. This may be accomplished by blockchain related application 160 (e.g., via a corresponding smart contact 146 and/or distributed application (dApp) 148) providing a transaction to the blockchain indicating ownership of the on-chain version by the user. Further, various information for the on-chain asset (e.g., user information, asset information, wallet information, etc.) may be stored on-chain and/or in off-chain storage (e.g., database system 118, etc.). In addition, the management module directs registration module 132 of registration system 130 to register the name of the off-chain asset to the user at flow 730.

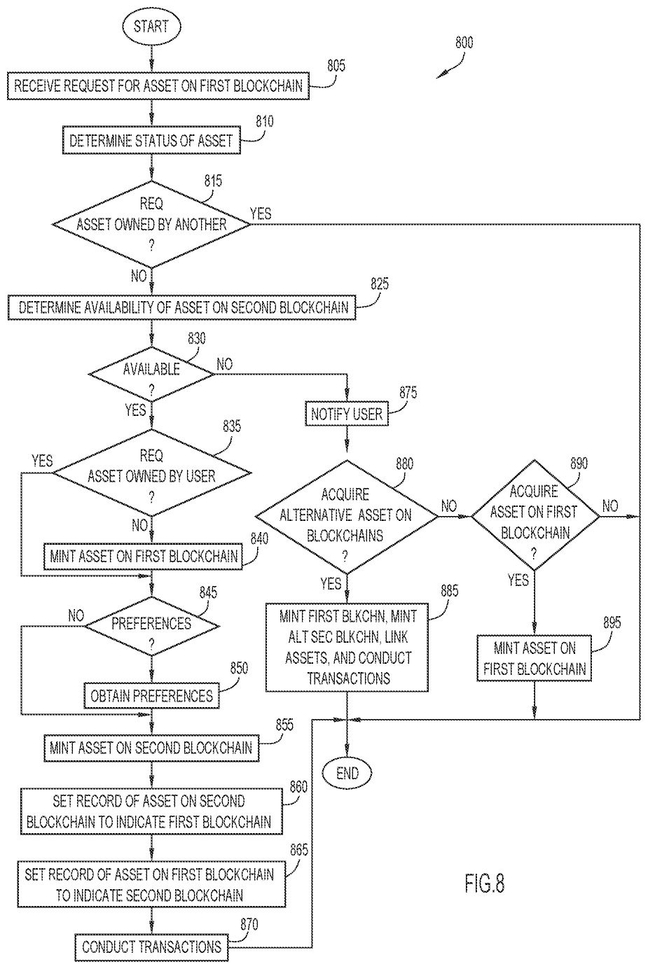

A method 800 of registering and utilizing a name or other identifier for an on-chain asset of a second system (e.g., Web3, blockchain, etc.) based on a name or other identifier for an on-chain asset of different first system (e.g., Web3, blockchain, etc.) according to an embodiment of the present invention is illustrated in FIG. 8. Initially, a user may register, or desire to register, a name or other identifier for an on-chain asset of a first system (e.g., Web3, blockchain and/or smart contract, etc.) via management module 116 of server system 110. The user may further desire to register the name or other identifier of the on-chain asset on a second different system (e.g., Web3, blockchain and/or smart contract, etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the on-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the on-chain asset for the first system at operation 805. The management module performs a look-up of the name of the on-chain asset for the first system at operation 810 to determine registration/ownership of the on-chain asset by another user (e.g., indicating unavailability of the on-chain asset on the first system). By way of example, the on-chain asset may include an on-chain domain name (e.g., Web3, blockchain, etc.). In this case, the management module (e.g., via blockchain related application 160) accesses a corresponding blockchain 142 for the on-chain asset (e.g., via a blockchain system 140), and performs a look-up for the name of the on-chain asset on the blockchain. Absence of a record on the blockchain for the name indicates the name for the on-chain asset is available on the blockchain. The blockchain may be determined based on the extension of the name.

When the on-chain asset is not registered/owned by another user on the first system as determined at operation 815, management module 116 determines availability of the name of the on-chain asset for an on-chain asset of a second different system (e.g., different blockchain, etc.) at operation 825. In other words, management module determines availability of an on-chain equivalent of the second system for the on-chain asset of the first system. For example, management module 116 (e.g., via blockchain related application 160) accesses a different blockchain 142 corresponding to the second system for the on-chain asset (e.g., via a blockchain system 140), and performs a look-up for the name of the on-chain asset on the different blockchain. Absence of a record on the different blockchain for the name indicates the name for the on-chain asset is available on the different blockchain.

When a representation of the on-chain asset of the first system is available on the second system as determined at operation 830, the name for the on-chain asset is registered on the first system at operation 840 when the name for the on-chain asset is available on the first system (and not registered/owned by the user) as determined at operation 835. For example, management module 116 (e.g., via blockchain related application 160, a corresponding smart contract 146, and/or distributed application (dApp) 148) mints (or publishes) the name for the on-chain asset on a blockchain corresponding to the first system. The minting may be performed based on any required preferences. This may be accomplished by management module 116 (e.g., via blockchain related application 160, a corresponding smart contract 146, and/or distributed application (dApp) 148) providing a transaction to the blockchain corresponding to the first system indicating ownership of the on-chain asset by the user. In addition, various information for the on-chain asset (e.g., user information, asset information, wallet information, etc.) may be stored on-chain and/or in off-chain storage (e.g., database system 118, etc.).

Payment and other preferences may be provided or selected for acquiring (or minting) the on-chain version for the second system. The options or preferences may include payment to acquire the on-chain representation, a time period for the registration (e.g., months, years, etc.), etc. When preferences are required as determined at operation 845, management module 116 obtains the preferences at operation 850. For example, the preferences may be stored in database system 118, or received from an administrator.

The name for the on-chain version for the second system is acquired at operation 855. For example, management module 116 (e.g., via blockchain related application 160, a corresponding smart contract 146, and/or distributed application (dApp) 148) mints (or publishes) the name for the on-chain asset on a blockchain corresponding to the second system. The minting may be performed based on any required preferences. This may be accomplished by management module 116 (e.g., via blockchain related application 160, a corresponding smart contract 146, and/or distributed application (dApp) 148) providing a transaction to the blockchain corresponding to the second system indicating ownership of the on-chain asset by the user. In addition, various information for the on-chain asset (e.g., user information, asset information, wallet information, etc.) may be stored on-chain and/or in off-chain storage.

In order to link the on-chain versions of the first and second systems, management module 116 (e.g., via corresponding smart contracts 146, distributed application (dApp) 148, and/or blockchain related application 160) sets a record associated with the on-chain asset on the second system to indicate the on-chain asset of the first system at operation 860. For example, an on-chain or off-chain record may be created or modified to include an identifier for the on-chain asset of the second system (e.g., an on-chain domain name to be linked, etc.).

In addition, management module 116 (e.g., via a corresponding smart contract 146, distributed application (dApp) 148, and/or blockchain related application 160) sets a record associated with the on-chain asset of the first system to indicate the on-chain representation of the second system at operation 865. For example, an on-chain or off-chain record may be created or modified to include an identifier for the on-chain asset of the second system (e.g., an on-chain domain name to be linked, etc.).

Once the records linking the on-chain representations are processed, transactions are conducted (e.g., via management module 116 and/or blockchain related application 160) at operation 870 using the names for the on-chain assets. For example, the information in the record for the on-chain asset of a system may be used to resolve data for accessing or performing transactions with respect to the on-chain asset of the other system (e.g., a user may send cryptocurrency to the name of the on-chain asset on the first system by a look-up of records for the name on the second system, etc.). Further, transactions conducted for an on-chain representation may automatically be applied to the linked representation based on the linking information. By way of example, selling an on-chain representation also sells the linked on-chain representation, transferring the on-chain representation also transfers the linked on-chain representation, making available for auction the on-chain representation also makes the linked on-chain representation available, purchasing an on-chain representation brand new also purchases the linked on-chain representation, taking out a loan may apply to the linked representations or be conducted using one of the linked representations, extending expiration of (or renewing) an on-chain representation extends (or renews) the registration for a linked on-chain representation, and/or transferring an on-chain domain to a new registrar (in the case of domains) transfers the linked on-chain domain to the new registrar or the transfer may be conducted using one of the linked representations.

When the name of the on-chain asset for the first system is not available on the second system based on the look-up (e.g., an on-chain representation of the on-chain asset of the first system is already present on the second system) as determined at operation 830, management module 116 alerts or notifies the user at operation 875. The notification may indicate ownership information for the on-chain asset of the second system (e.g., blockchain address, etc.), and/or expiration information for the on-chain asset of the second system. In addition, management module 116 may determine an alternative name that is available on the second system and partially matches the name for the on-chain asset of the first system (e.g., the alternative name may include the same name portion with a different extension, a numerical or other sequence appended to the name portion, etc.). Management module 116 may perform a look-up (e.g., via blockchain related application 160) in substantially the same manner described above to determine and/or confirm availability of the alternative name on the second system.

Management module 116 may present the alternative name and request an indication from the user to acquire the alternative name for the on-chain asset. When the user desires to acquire the alternative name for the on-chain asset as determined at operation 880, the management module registers the name of the on-chain asset on the first system (when not owned by the user), registers the alternative name for the on-chain asset on the second system, links the on-chain assets of the first and second systems, and conducts transactions at operation 885 in substantially the same manner described above (e.g., for operations 835-870).

When the name of the on-chain asset of the first system is available for registration (e.g., not already registered/owned by the user), the user may still acquire the on-chain asset on the first system even though an on-chain version may be unavailable on the second system (e.g., due to the existence of a conflicting on-chain asset, etc.). In this case, management module 116 may request an indication from the user to acquire the name for the on-chain asset on the first system. When the user desires to acquire the name for the on-chain asset on the first system (without the on-chain version on the second system) as determined at operation 890, management module 116 (e.g., via blockchain related application 160, a corresponding smart contract 146, and/or distributed application (dApp) 148) registers the name of the on-chain asset on the first system to the user at operation 895. By way of example, management module 116 (e.g., via blockchain related application 160, a corresponding smart contract 146, and/or distributed application (dApp) 148) may provide a transaction to the blockchain indicating ownership of the on-chain asset on the first system by the user in substantially the same manner described above. In addition, various information for the on-chain asset (e.g., user information, asset information, wallet information, etc.) may be stored on-chain and/or in off-chain storage (e.g., database system 118, etc.) in substantially the same manner described above.

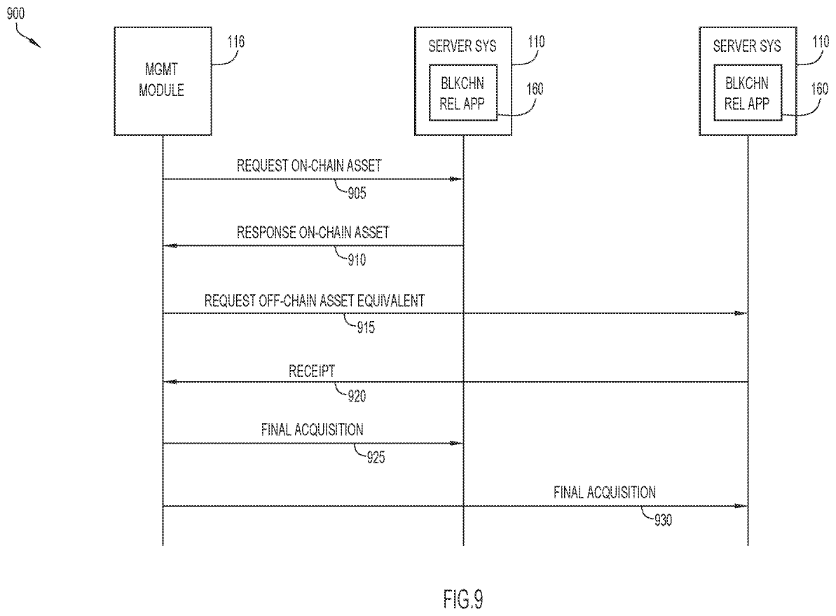

A method 900 of registering a name or other identifier for an on-chain asset of a second system (e.g., Web3, blockchain, etc.) based on a name or other identifier for an on-chain asset of a first different system (e.g., Web3, blockchain, etc.) according to an embodiment of the present invention is illustrated in FIG. 9. Initially, a user may register, or desire to register, a name or other identifier for an on-chain asset on a first system (e.g., Web3, blockchain, etc.) via management module 116 of server system 110. The user may further desire to register the name or other identifier of the on-chain asset for an on-chain asset of a second different system (e.g., Web3, blockchain, etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the on-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the on-chain asset for the first system, and performs a look-up of the name of the on-chain asset to determine availability of the name of the on-chain asset on the first system for registration. For example, the management module sends a request to a blockchain related application 160 at flow 905 concerning the availability. The blockchain related application accesses a blockchain 142 corresponding to the first system for the on-chain asset (e.g., via a blockchain system 140), and performs a look-up for the name of the on-chain asset on the blockchain corresponding to the first system. Absence of a record on the blockchain for the name indicates the name for the on-chain asset is available on the blockchain corresponding to the first system. Blockchain related application 160 sends a response indicating availability of the on-chain asset on the first system to management module 116 at flow 910.

When the on-chain asset is available for registration on the first system, management module 116 determines availability of the name of the on-chain asset for registration on the second system. In other words, management module determines availability of an on-chain equivalent of the on-chain asset of the first system on the second system. For example, the management module sends a request to a blockchain related application 160 for the second system at flow 915 concerning the availability. The blockchain related application accesses a blockchain 142 corresponding to the second system for the on-chain asset (e.g., via a blockchain system 140), and performs a look-up for the name of the on-chain asset on the blockchain corresponding to the second system. Absence of a record on the blockchain for the name indicates the name for the on-chain asset is available on the blockchain corresponding to the second system. Blockchain related application 160 sends a response indicating availability of the on-chain asset on the second system to management module 116 at flow 920.

Management module 116 directs blockchain related application 160 to mint (or publish) the on-chain asset on the first system at flow 925. For example, blockchain related application 160 (e.g., via a corresponding smart contract 146 and/or distributed application (dApp) 148) mints (or publishes) the name for the on-chain asset on a blockchain corresponding to the first system. This may be accomplished by blockchain related application 160 (e.g., via a corresponding smart contract 146 and/or distributed application (dApp) 148) providing a transaction to the blockchain corresponding to the first system indicating ownership of the on-chain asset by the user. Further, various information for the on-chain asset (e.g., user information, asset information, wallet information, etc.) may be stored on-chain and/or in off-chain storage (e.g., database system 118, etc.).

In addition, the management module directs blockchain related application 160 to mint (or publish) the on-chain asset on the second system at flow 930. For example, blockchain related application 160 (e.g., via a corresponding smart contract 146 and/or distributed application (dApp) 148) mints (or publishes) the name for the on-chain asset on a blockchain corresponding to the second system. This may be accomplished by blockchain related application 160 (e.g., via a corresponding smart contract 146 and/or distributed application (dApp) 148) providing a transaction to the blockchain corresponding to the second system indicating ownership of the on-chain asset by the user. Further, various information for the on-chain asset (e.g., user information, asset information, wallet information, etc.) may be stored on-chain and/or in off-chain storage (e.g., database system 118, etc.).

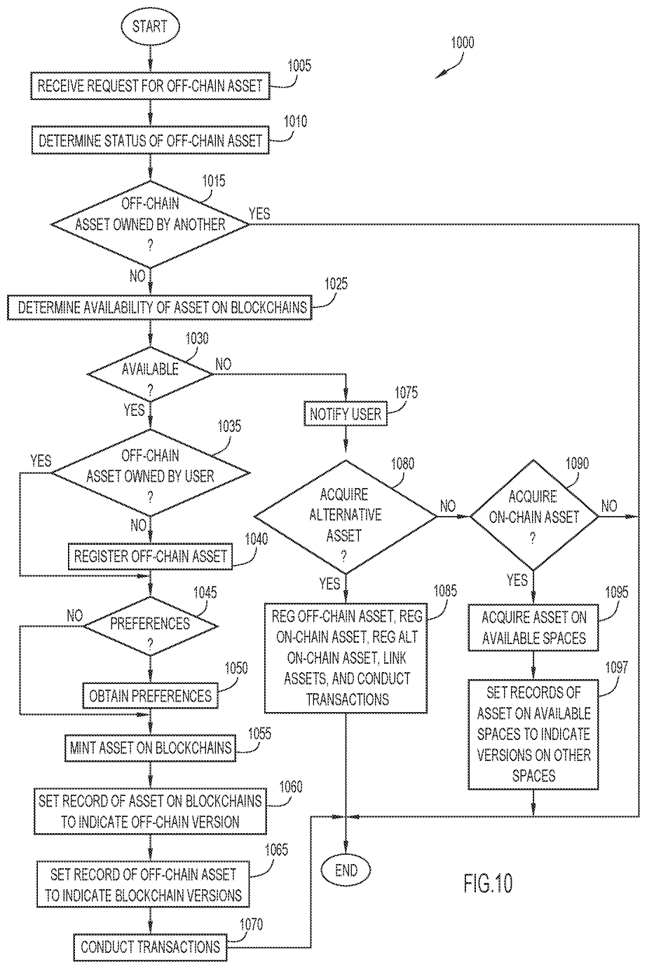

The embodiments of the present invention described above generally relate to a link between an on-chain asset and an off-chain asset, or an on-chain asset and an on-chain asset. However, embodiments of the present invention may be applied for any number of off-chain and on-chain assets (e.g., an off-chain or on-chain asset that links to one or more off-chain and/or on-chain assets, etc.). A method 1000 of registering and utilizing a name or other identifier for plural on-chain assets of different systems (e.g., Web3, blockchain, etc.) based on a name or other identifier of an off-chain asset (e.g., Web2, Domain Name System (DNS), etc.) according to an embodiment of the present invention is illustrated in FIG. 10. Initially, a user may register, or desire to register, a name or other identifier for an off-chain asset (e.g., Web2, Domain Name System (DNS), etc.) via management module 116 of server system 110. The user may further desire to register the name or other identifier of the off-chain asset for a plurality of on-chain assets of different systems (e.g., Web3, blockchains and/or smart contracts, etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the off-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the off-chain asset at operation 1005. The management module performs a look-up of the name of the off-chain asset at operation 1010 to determine registration/ownership of the off-chain asset by another user (e.g., indicating unavailability of the off-chain asset). By way of example, the off-chain asset may include an off-chain domain name (e.g., Web2, Domain Name System (DNS), etc.), and management module 116 requests information (e.g., DNS records, etc.) for the off-chain domain name from registration system 130. The information from the registration system indicates registration/ownership or availability of the off-chain domain name.

When the off-chain asset is not registered/owned by another user as determined at operation 1015, management module 116 determines availability of the name of the off-chain asset for an on-chain asset of plural systems (e.g., blockchains, etc.) at operation 1025. In other words, management module determines availability of an on-chain equivalent of the off-chain asset on plural different systems (e.g., blockchains, etc.). The systems may be predetermined, or selected by a user. For example, the management module (e.g., via blockchain related application 160) accesses intended blockchains 142 for the on-chain versions (e.g., via a blockchain systems 140), and performs a look-up for the name of the off-chain asset on the blockchains. Absence of a record on an intended blockchain for the name indicates the name for the off-chain asset (or on-chain version) is available on that blockchain. The intended blockchains may be selected by a user, and the name for the look-up may include the name portion of the name of the off-chain asset (e.g., with the same extension, a corresponding extension for the intended blockchain, etc.).

When on-chain representations of the off-chain asset is available on the plurality of systems as determined at operation 1030, the name for the off-chain asset is registered off-chain at operation 1040 when the name for the off-chain asset is available (and not registered/owned by the user) as determined at operation 1035. In this case, management module 116 (e.g., via registration module 132 of registration system 130) registers the name of the off-chain asset to the user. By way of example, registration module 132 creates a set of one or more (e.g., Domain Name System (DNS)) records containing access and other information when an off-chain domain name is registered. For example, the records may include records of one or more record types including an address (or A) record, a hostname pointing (or canonical name (CNAME) alias) record, a mail (or MX) record, a name server (or NS) record, a private name server record, a start of authority (or SOA) record, a text (or TXT/SPF) record, and a service (or SRV) record.

Payment and other preferences may be provided or selected for acquiring the on-chain versions on the plurality of systems. The options or preferences may include payment to acquire the on-chain representations, intended systems or blockchains to register the on-chain versions, smart contracts for the transaction, etc. When preferences are required as determined at operation 1045, management module 116 obtains the preferences at operation 1050. For example, the preferences may be stored off-chain in database system 118, or received from an administrator.

The name for the on-chain versions are acquired at operation 1055. For example, management module 116 (e.g., via blockchain related application 160, corresponding smart contracts 146, and/or distributed application (dApp) 148) mints (or publishes) the name for the on-chain versions on corresponding blockchains. The minting may be performed based on any required preferences. This may be accomplished by management module 116 (e.g., via blockchain related application 160, corresponding smart contracts 146, and/or distributed application (dApp) 148) providing a transaction to the blockchains indicating ownership of the on-chain versions by the user. In addition, various information for the on-chain versions (e.g., user information, asset information, wallet information, etc.) may be stored on-chain and/or in off-chain storage (e.g., database system 118, etc.).

In order to link the off-chain and on-chain versions, management module 116 (e.g., via corresponding smart contracts 146, distributed application (dApp) 148, and/or blockchain related application 160) sets a record associated with the on-chain assets to indicate the off-chain asset at operation 1060. For example, an on-chain or off-chain record may be created or modified to include an identifier for the off-chain asset (e.g., an off-chain domain name to be linked, etc.).

In addition, management module 116 (e.g., via registration module 132 of registration system 130) sets a record associated with the off-chain asset to indicate the on-chain representations at operation 1065. For example, a Domain Name System (DNS) canonical name or other record may be created or modified to include an identifier for the on-chain assets (e.g., on-chain domain names, wallet addresses, etc.).

Once the records linking the on-chain and off-chain representations are processed, transactions are conducted (e.g., via management module 116 and/or blockchain related application 160) at operation 1070 using the names for the on-chain or off-chain assets. For example, the information in the record for the off-chain asset may be used to resolve data for the on-chain representations (e.g., a user may send cryptocurrency to an off-chain asset (based on an associated record indicating the on-chain assets), etc.). The transaction may be analyzed to determine the actions, underlying system, and the corresponding representation needed for that system. By way of example, when the transaction is for one or more on-chain representations (or domains) for on-chain systems using an off-chain representation (or domain), a lookup of the Domain Name System (DNS) canonical name or other record associated with the off-chain representation (e.g., web2/off-chain/DNS version of the on-chain domain) is performed to obtain the on-chain representations for conducting the transaction. A similar approach may be used for off-chain transactions using on-chain representations. Further, transactions conducted for an on-chain or off-chain representation may automatically be applied to the linked representations based on the linking information. By way of example, selling an on-chain or off-chain representation also sells one or more of the linked representations, transferring the on-chain or off-chain representation also transfers one or more of the linked representations, making available for auction the on-chain or off-chain representation also makes one or more of the linked representations available, purchasing an on-chain or off-chain representation brand new also purchases one or more of the linked representations, taking out a loan may apply to the linked representations or be conducted using one or more of the linked representations, extending expiration of (or renewing) an on-chain or off-chain representation extends (or renews) the registration for one or more of the linked representations, and/or transferring an on-chain or off-chain domain to a new registrar (in the case of domains) transfers one or more of the linked representations to the new registrar or the transfer may be conducted using one of the linked representations.

When the name of the off-chain asset is not available on one or more of the plurality of systems based on the look-up (e.g., an on-chain representation of the off-chain asset is already present on one or more of the systems) as determined at operation 1030, management module 116 alerts or notifies the user at operation 1075. The notification may indicate ownership information for the one or more on-chain versions of the off-chain asset (e.g., blockchain address, etc.), and/or expiration information for the on-chain assets. In addition, management module 116 may determine an alternative name that is available on the systems having the on-chain versions and partially matches the name for the off-chain asset (e.g., the alternative name may include the same name portion with a different extension, a numerical or other sequence appended to the name portion, etc.). Management module 116 may perform a look-up (e.g., via blockchain related application 160) in substantially the same manner described above to determine and/or confirm availability of the alternative name on the systems.

Management module 116 may present the alternative name and request an indication from the user to acquire the alternative name for the systems where the on-chain assets are already present. When the user desires to acquire the alternative name for the on-chain assets as determined at operation 1080, the management module registers the name of the off-chain asset (when not owned by the user), registers the name on systems with availability for the name, registers the alternative name on the systems without availability for the name, links the off-chain and on-chain assets, and conducts transactions at operation 1085 in substantially the same manner described above (e.g., for operations 1035-1070).

When the name of the off-chain asset is available for registration (e.g., not already registered/owned by the user), the user may still acquire the off-chain asset and any on-chain assets having availability for the name even though an on-chain version may be unavailable (e.g., due to the existence of a conflicting on-chain asset, etc.). For example, management module 116 may request an indication from the user to acquire the name for the off-chain asset and the available on-chain assets. When the user desires to acquire the name for the off-chain asset and available on-chain assets as determined at operation 1090, management module 116 (e.g., via registration module 132 of registration system 130) registers the name of the off-chain asset to the user at operation 1095. By way of example, registration module 132 creates a set of one or more (e.g., Domain Name System (DNS)) records containing access and other information when an off-chain domain name is registered in substantially the same manner described above. Further, management module 116 (e.g., via blockchain related application 160, a corresponding smart contract 146, and/or distributed application (dApp) 148) registers the name of the off-chain asset to the user on the systems with availability at operation 1095. By way of example, management module 116 (e.g., via blockchain related application 160, corresponding smart contracts 146, and/or distributed application (dApp) 148) may provide a transaction to the blockchains indicating ownership of the on-chain assets by the user in substantially the same manner described above. In addition, various information for the on-chain assets (e.g., user information, asset information, wallet information, etc.) may be stored on-chain and/or in off-chain storage (e.g., database system 118, etc.) in substantially the same manner described above.

The off-chain and on-chain assets are linked at operation 1097 (to conduct transactions as described above). In order to link the off-chain and on-chain versions, management module 116 (e.g., via corresponding smart contracts 146, distributed application (dApp) 148, and/or blockchain related application 160) sets a record associated with the on-chain assets to indicate the off-chain asset. For example, an on-chain or off-chain record may be created or modified to include an identifier for the off-chain asset (e.g., an off-chain domain name to be linked, etc.). In addition, management module 116 (e.g., via registration module 132 of registration system 130) sets a record associated with the off-chain asset to indicate the on-chain representations. For example, a DNS record may be created or modified to include an identifier for the on-chain assets (e.g., on-chain domain names, wallet addresses, etc.).

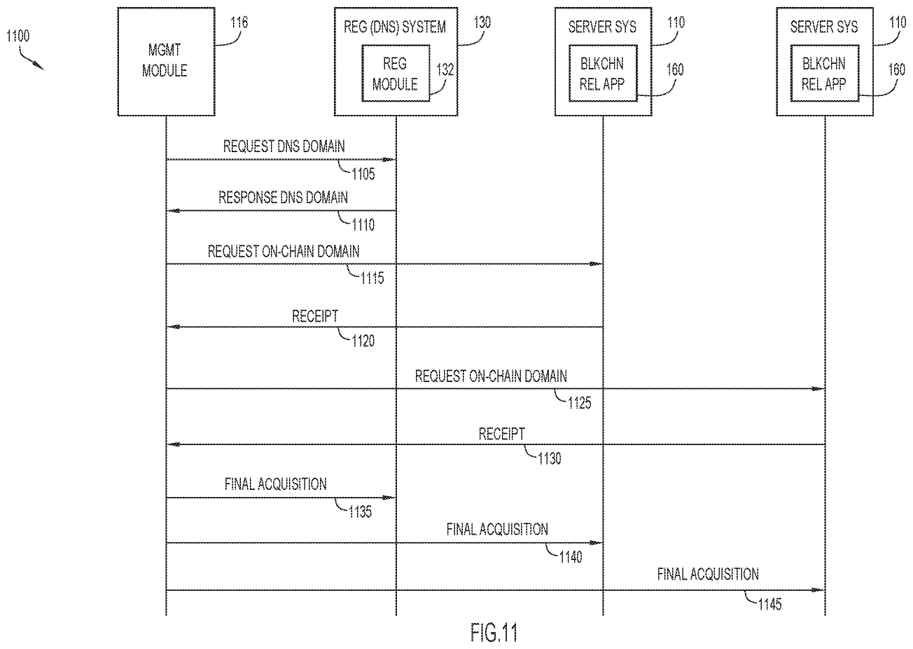

A method 1100 of registering a name or other identifier for plural on-chain assets of different systems (e.g., Web3, blockchain, etc.) based on a name or other identifier of an off-chain asset (e.g., Web2, Domain Name System (DNS), etc.) according to an embodiment of the present invention is illustrated in FIG. 11. Initially, a user may register, or desire to register, a name or other identifier for an off-chain asset (e.g., Web2, Domain Name System (DNS), etc.) via management module 116 of server system 110. The user may further desire to register the name or other identifier of the off-chain asset for an on-chain asset of plural different systems (e.g., Web3, blockchains and/or smart contracts, etc.). An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). The name or other identifier for the off-chain asset may include a name portion and an optional extension (e.g., “name.e1”, etc.). Alternatively, the name or other identifier may include the name portion without the extension. The name portion and extension may each include any quantity of terms, words, tokens, or arrangements of any quantity of any types of elements (e.g., alphanumeric or other characters, symbols, numbers, etc.).

Management module 116 receives a request for the name or other identifier of the off-chain asset, and performs a look-up of the off-chain asset to determine availability of the off-chain asset for registration. By way of example, the off-chain asset includes a Domain Name System (DNS) domain name. Management module 116 requests information for the DNS domain name from registration module 132 of registration system 130 (e.g., a DNS server, etc.) at flow 1105. The registration module performs the look-up, and provides a response at flow 1110 indicating availability of the DNS domain name.

When the DNS domain name is available for registration, management module 116 determines availability of the DNS domain name for on-chain assets of different systems. In other words, management module determines availability of an on-chain equivalent of the DNS domain name. For example, the management module sends a request to blockchain related application 160 at flow 1115 concerning the availability on an intended blockchain. The blockchain related application accesses the intended blockchain 142 for an on-chain version (e.g., via a blockchain system 140), and performs a look-up for the DNS domain name on the intended blockchain. Absence of a record on the intended blockchain for the DNS domain name indicates the DNS domain name (or on-chain version) is available on the intended blockchain.

Blockchain related application 160 sends a response or receipt indicating availability of the DNS domain name on the intended blockchain to management module 116 at flow 1120.

Further, the management module sends a request to blockchain related application 160 at flow 1125 concerning the availability on a second intended blockchain. The blockchain related application accesses the second intended blockchain 142 for an on-chain version (e.g., via a blockchain system 140), and performs a look-up for the DNS domain name on the second intended blockchain. Absence of a record on the second intended blockchain for the DNS domain name indicates the DNS domain name (or on-chain version) is available on the intended blockchain.

Blockchain related application 160 sends a response or receipt indicating availability of the DNS domain name on the second intended blockchain to management module 116 at flow 1130.

Once the DNS domain name is available on the intended blockchains, management module 116 directs registration module 132 of registration system 130 to register the DNS domain name (off-chain) to the user at flow 1135. Further, the management module directs blockchain related applications 160 to mint the on-chain versions to the intended blockchains at flows 1140, 1145. For example, blockchain related applications 160 (e.g., via corresponding smart contract 146 and/or distributed application (dApp) 148) mints (or publishes) the name for the on-chain version on the corresponding blockchains. This may be accomplished by blockchain related application 160 (e.g., via corresponding smart contract 146 and/or distributed application (dApp) 148) providing transactions to the corresponding blockchains indicating ownership of the on-chain versions by the user. In addition, various information for the on-chain versions (e.g., user information, asset information, wallet information, etc.) may be stored on-chain and/or in off-chain storage (e.g., database system 118, etc.).

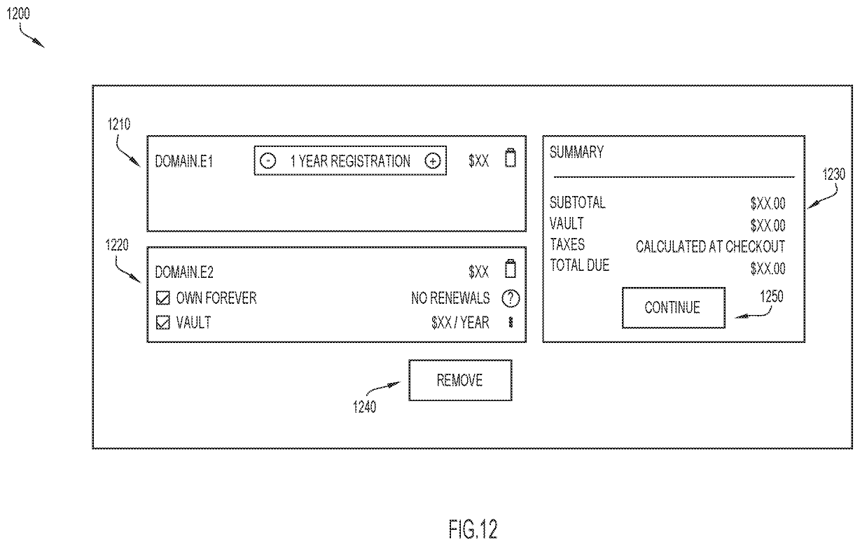

Operation of an embodiment of the present invention for an example scenario is described with respect to FIG. 12. Initially, a user desires to acquire an on-chain domain name (e.g., DOMAIN.E2 as viewed in FIG. 12). Management module 116 provides a user interface 1200 to enable entry and acquisition of the on-chain domain name (e.g., Web3, blockchain, etc.). The user interface includes domain areas 1210, 1220. By way of example, domain area 1220 provides information pertaining to the on-chain domain name (e.g., DOMAIN.E2), including amounts for the acquisition, renewals, and storage. Management module 116 performs a look-up of the on-chain domain name (e.g., via registration system 130) to determine availability of the domain name off-chain (e.g., Web2, Domain Name System (DNS), etc.) in substantially the same manner described above. In other words, the look-up determines availability of an equivalent off-chain asset (e.g., a DNS domain name).

When the off-chain domain name is available, management module 116 presents the off-chain domain name on user interface 1200 in domain area 1210. Domain area 1210 provides information pertaining to the off-chain domain name (e.g., DOMAIN.E1 as viewed in FIG. 12), including amounts for the registration. The user may select to acquire the on-chain domain name, the off-chain domain name, or both (e.g., remove unwanted domain names via actuation of corresponding delete actuators, etc.). In addition, the user may remove the on-chain and-off chain domain names via actuation of a remove actuator 1240. Thus, the management module 116 may provide options for additional registrations (e.g., on-chain domain names, off-chain domain names, etc.) based on an entered domain name. User interface 1200 may further provide a total amount for selected domain names below domain area 1220.

User interface 1200 further includes a summary area 1230. The summary area lists the total fees (e.g., including amounts, storage, and taxes). A user may proceed to acquire the selected domain names via actuation of a continue actuator 1250.

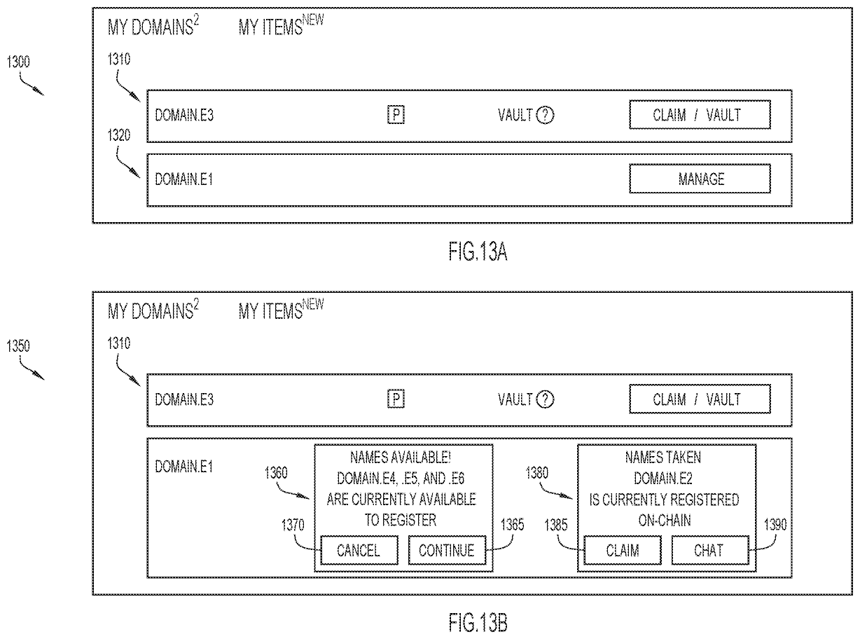

Operation of an embodiment of the present invention for an example scenario is described with respect to FIGS. 13A and 13B. Initially, a user may request a listing of their registered domain names. Management module 116 may perform a look-up (e.g., via registration system 130 and blockchain system 140) in substantially the same manner described above to identify the registered domain names of the user. The management module provides the identified domain names on a user interface 1300 (e.g., off-chain DOMAIN.E1 as viewed in FIG. 13A). User interface 1300 includes an actuator 1310 to enable storage or proof of ownership of a corresponding on-chain domain name (e.g., DOMAIN2.E3 as viewed in FIG. 13A), and a manage actuator 1320 to provide domain information and enable various actions (e.g., renew, transfer, discard, etc.) for a corresponding domain name (e.g., DOMAIN.E1 as viewed in FIG. 13A).

Management module 116 may enable the user to view from the listing of domain names the availability of the equivalent on-chain or off-chain domain names. The management module provides the listing of domain names on a user interface 1350 (FIG. 13B). User interface 1350 provides a listing of domain names in substantially the same manner described above for user interface 1300. Management module 116 may determine availability of on-chain or off-chain equivalents by performing look-ups (e.g., via blockchain system 140 or registration system 130) in substantially the same manner described above. The management module may alert the user of availability of the equivalents. For example, the user may own an off-chain domain name (e.g., DOMAIN.E1 as viewed in FIG. 13B). In this case, management module 116 performs a look-up (e.g., via blockchain systems 140) to determine availability of on-chain equivalents in substantially the same manner described above. By way of example, management module 116 may present a dialog box 1360 indicating availability of on-chain equivalents (e.g., DOMAIN.E4, DOMAIN.E5, and DOMAIN.E6 as shown in FIG. 13B). The user may select these on-chain equivalents to acquire via actuation of a continue actuator 1365, or cancel acquisition via actuation of a cancel actuator 1370.

When the equivalents are acquired, the records for the on-chain domain names and/or the records for the off-chain domain name may be updated to reflect the relationship. For example, Domain Name System (DNS) records of a DNS domain name may set a TXT or other DNS record to indicate the on-chain domain names. Further, records of the on-chain domain names may be updated to indicate an off-chain DNS record.

Alternatively, an on-chain equivalent domain may be unavailable. For example, management module 116 may present a dialog box 1380 indicating unavailability of an on-chain equivalent (e.g., DOMAIN.E2 is currently registered as shown in FIG. 13B). The user may actuate a claim actuator 1385 to enable the user to prove ownership of the on-chain equivalent (e.g., via a signed message from a wallet corresponding to the on-chain domain name, etc.), or initiate a chat or other communication session with a current owner to acquire the on-chain equivalent via actuation of a chat actuator 1390. Once the domain names are secured, the on-chain and off-chain domain names are linked via record updates in substantially the same manner described above.

Present invention embodiments may provide various technical and other advantages. For example, present invention embodiments provide enhanced manners of accessing an asset, and enable use of asset identifiers (and access of corresponding assets) across different networks (e.g., DNS and blockchain, etc.). In addition, present invention embodiments enable transactions using any of the corresponding off-chain and on-chain identifiers or domain names, thereby providing new functionality to an identifier of a network that are absent on that network (e.g., send cryptocurrency to a Web2 domain name, access/perform transactions on blockchains with domain names of other blockchains, etc.).

It will be appreciated that the embodiments described above and illustrated in the drawings represent only a few of the many ways of implementing embodiments for asset utilization across on-chain and off-chain systems. In addition, characteristics or features of embodiments of the present invention may be combined in any fashion to provide additional embodiments of the present invention.

The environment of the present invention embodiments may include any number of computer or other processing systems (e.g., client or end-user systems, server systems, blockchain systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, hand-held devices, smartphones or other mobile devices, etc.), and may include any commercially available operating system and any combination of commercially available and custom software (e.g., communications software; server software; software of present invention embodiments (including management module 116, interface module 122, registration module 132, smart contracts 146, distributed applications (dApps) 148, blockchain related applications 160, etc.); etc.). These systems may include any types of monitors and input devices (e.g., keyboard, mouse, voice recognition, etc.) to enter and/or view information.

It is to be understood that the software of the present invention embodiments (e.g., management module 116, interface module 122, registration module 132, smart contracts 146, distributed applications (dApps) 148, blockchain related applications 160, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, server, authentication server, blockchain, and resource server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., management module 116, interface module 122, registration module 132, smart contracts 146, distributed applications (dApps) 148, blockchain related applications 160, etc.) may be available on a non-transitory computer useable or readable medium (e.g., magnetic or optical mediums, magneto-optic mediums, CD-ROM, DVD, memory devices, etc.) of a stationary or portable computer program product, apparatus, or device for use with stand-alone systems or systems connected by a network or other communications medium. The computer useable or readable medium (or media) may include instructions executable by one or more processors to perform functions of present invention embodiments described herein.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., verification results, domain information, mappings of assets to systems, etc.). The database system may be implemented by any number of any conventional or other databases, data stores or storage structures to store information. The database system may be included within or coupled to the server, client, registration, and/or blockchain systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., asset identifiers, results of an access request, name and/or other attributes of an asset, domain information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The report may include any information arranged in any fashion, and may be configurable based on rules or other criteria to provide desired information to a user (e.g., registered or other assets, results of an access request, verification results, domain information, etc.).

The present invention embodiments are not limited to the specific tasks or algorithms described above, but may be utilized for managing domain names or other assets across any quantity of systems (e.g., between off-chain and on-chain, on-chain and on-chain, off-chain or on-chain and one or more on-chain systems, etc.). Further, present invention embodiments are described with respect to assets including domains or domain names. However, the present invention embodiments may be utilized for acquiring and providing associations between any types of assets in substantially the same manner described above.

The present invention embodiments may process requests from any entity (e.g., user, application, service, computing or other device, etc.), and utilize any on-chain or off-chain asset or identifier to access any items on or off a blockchain. An asset may include any item or object associated with a computer or network environment (e.g., a domain, a domain name, a set of records, an object that points to a set of records, a non-fungible token (NFT), non-fungible token (NFT) domain names, a fungible token, a wallet address, email or other service, communication entity, etc.). An on-chain asset may include any asset residing on, or supported by, a blockchain or other decentralized system (e.g., Web3 asset, asset of a decentralized system, asset of a partial or hybrid decentralized system, etc.). An off-chain asset may include any asset residing on, or supported by, a centralized system or a system with centralized control (e.g., Web2, Domain Name System (DNS), system other than a decentralized system described above, etc.). An on-chain system may include any blockchain or other decentralized system (e.g., Web3, decentralized system, partial or hybrid decentralized system, etc.), while an off-chain system may include any centralized system or system with centralized control (e.g., Web2, Domain Name System (DNS), system other than a decentralized system described above, etc.).

The asset identifier (e.g., for an-chain or off-chain asset, etc.) may be indicated by any name or identifier including any quantity of terms, words, tokens, or arrangements of any quantity of any types of elements (e.g., alphanumeric or other characters, symbols, numbers, etc.). The name or identifier preferably includes a name or identifier portion and an optional extension (e.g., “name.e1”, etc.). Alternatively, the name or identifier may include the name or identifier portion without the extension. The name and/or extension may be used for partial or exact matching for name look-ups (e.g., to obtain blockchain (or wallet) addresses and/or other attributes, etc.). The name or identifier portion and extension may each include any quantity of terms, words, tokens, or arrangements of any quantity of any types of elements (e.g., alphanumeric or other characters, symbols, numbers, etc.). In some instances, an asset identifier may identify an asset and be the asset itself. For example, a domain name (e.g., on-chain or off-chain) may be an asset to be acquired, and also serve as an identifier for that asset (or itself). Further, registration of an asset identifier by a user effectively provides acquisition (e.g., registration, ownership, rights, etc.) of the corresponding asset by the user.

Any quantity of any parameters, values, or other information may be associated with an asset. The information for an-off chain asset may include any information arranged in any fashion (e.g., values for domain records, domain parameters, server names or addresses, etc.). Any information of an off-chain asset may be stored for an-chain asset to link the assets. This information may be stored on a blockchain and/or on an off-chain data source in any storage item (e.g., record, data object, etc.). The information for an-on chain asset may include any information arranged in any fashion (e.g., values for asset attributes, blockchain, wallet address, user/owner information etc.). Any information of an on-chain asset may be stored for an off-chain asset to link the assets. This information may be stored on a blockchain and/or on an off-chain data source in any storage item (e.g., record, data object, etc.). The off-chain data source may include any storage structure (e.g., decentralized storage structure or platform, blockchain storage, database, etc.). The asset information may be stored and retrieved based on any information (e.g., based on registered user information (e.g., wallet address, blockchain asset, blockchain domain or user name, user information, etc.).

The on-chain assets may be from any desired blockchains, and are preferably from different blockchains. Availability for an on-chain asset may be determined by searching any on-chain and/or off-chain storage for any corresponding records or information indicating existence of the on-chain asset on a system. Further, availability for an off-chain asset may be determined by searching any on-chain and/or off-chain storage for any corresponding records or information indicating existence of the off-chain asset on a system. Acquisition of an asset may be performed for any quantity of systems based on availability, where acquisition may be performed for all or a portion of the intended systems (e.g., acquisition may proceed when the asset is unavailable on one or more systems, etc.). Moreover, an alternative name or identifier may be determined for acquisition in any manner when an asset is unavailable on a system, and preferably includes at least some overlap with the original name (e.g., partially match, etc.). For example, the alternative name may include the same name portion with a different extension, a numerical or other sequence as a prefix or suffix to the name portion and/or extension, etc. In addition, the alternative name may be acquired on all of the desired systems (e.g., instead of the original name, etc.), or any combination of the original and alternative names may be acquired on any of the systems.

Any type of communication session (e.g., chat, text session, call, etc.) may be established to enable correspondence with an owner of a desired asset on a system. Further, verification of a user or ownership of an asset may be accomplished in any manner (e.g., signed message of a wallet, etc.). Acquisition of an asset may be performed in any manner (e.g., transaction on a blockchain (or minting) for an on-chain asset, registering an off-chain asset or creation of Domain Name System (DNS) or other records, etc.).

A name of an asset of a system may be used to access any corresponding assets of any other systems. For example, the information for the asset may indicate the information (e.g., names or identifiers, addresses, etc.) of the corresponding assets. The information may be retrieved based on the name of the asset and used to resolve the name of the asset to the location (e.g., system, name, address, etc.) of the corresponding assets on the other systems to access (and/or perform transactions) with respect to those corresponding assets. By way of example, a user may send cryptocurrency to a Web2 domain name, or access an asset of a first blockchain using a name of an asset of a second different blockchain.

Having described preferred embodiments of a new and improved system, method, and computer program product for asset utilization across on-chain and off-chain systems, it is believed that other modifications, variations and changes will be suggested to those skilled in the art in view of the teachings set forth herein. It is therefore to be understood that all such variations, modifications and changes are believed to fall within the scope of present invention embodiments as defined by the appended claims.

What is claimed is:

1. A method of accessing an asset of a system comprising:
acquiring an asset identifier for one or more second systems, via at least one processor, based on a corresponding asset identifier for a first system; and
linking, via the processor, the corresponding asset identifier for the first system and the asset identifier for the one or more second systems to enable access of an asset of the corresponding asset identifier on the first system using the asset identifier for the one or more second systems.

2. The method of claim 1, wherein the first system includes an off-chain system and the corresponding asset identifier includes an off-chain domain name, and wherein the one or more second systems each include an on-chain system and the asset identifier includes an on-chain domain name corresponding to the off-chain domain name.

3. The method of claim 2, wherein the on-chain system includes a blockchain and the on-chain domain name includes a blockchain domain name, and wherein the off-chain system includes a Domain Name System (DNS) and the off-chain domain name includes a Domain Name System (DNS) domain name.

4. The method of claim 2, wherein the one or more second systems include a plurality of second systems.

5. The method of claim 1, wherein the first system includes an on-chain system and the corresponding asset identifier includes an on-chain domain name, and wherein a second system includes an off-chain system and the asset identifier includes an off-chain domain name corresponding to the on-chain domain name.

6. The method of claim 5, wherein the on-chain system includes a blockchain and the on-chain domain name includes a blockchain domain name, and wherein the off-chain system includes a Domain Name System (DNS) and the off-chain domain name includes a Domain Name System (DNS) domain name.

7. The method of claim 1, wherein acquiring the asset identifier for the one or more second systems further comprises:
acquiring an alternative asset identifier for a second system in response to the asset identifier being unavailable on the second system, wherein the alternative asset identifier partially matches the corresponding asset identifier.

8. The method of claim 1, wherein linking the corresponding asset identifier for the first system and the asset identifier for the one or more second systems further comprises:
storing an indication of the asset identifier for the one or more second systems in information associated with the corresponding asset identifier; and
storing an indication of the corresponding asset identifier for the first system in information associated with each asset identifier for the one or more second systems.

9. The method of claim 3, wherein linking the corresponding asset identifier for the first system and the asset identifier for the one or more second systems further comprises:
storing an indication of the on-chain domain name in a Domain Name System (DNS) record for the off-chain domain name; and
conducting a transaction for the on-chain system using the off-chain domain name by retrieving the on-chain domain name from the Domain Name System (DNS) record for the off-chain domain name.

10. A system for accessing an asset comprising:
one or more memories; and
at least one processor coupled to the one or more memories, the at least one processor configured to:
acquire an asset identifier for one or more second systems based on a corresponding asset identifier for a first system; and
link the corresponding asset identifier for the first system and the asset identifier for the one or more second systems to enable access of an asset of the corresponding asset identifier on the first system using the asset identifier for the one or more second systems.

11. The system of claim 10, wherein the first system includes an off-chain system and the corresponding asset identifier includes an off-chain domain name, and wherein the one or more second systems each include an on-chain system and the asset identifier includes an on-chain domain name corresponding to the off-chain domain name.

12. The system of claim 11, wherein the on-chain system includes a blockchain and the on-chain domain name includes a blockchain domain name, and wherein the off-chain system includes a Domain Name System (DNS) and the off-chain domain name includes a Domain Name System (DNS) domain name.

13. The system of claim 11, wherein the one or more second systems include a plurality of second systems.

14. The system of claim 10, wherein the first system includes an on-chain system and the corresponding asset identifier includes an on-chain domain name, and wherein a second system includes an off-chain system and the asset identifier includes an off-chain domain name corresponding to the on-chain domain name.

15. The system of claim 14, wherein the on-chain system includes a blockchain and the on-chain domain name includes a blockchain domain name, and wherein the off-chain system includes a Domain Name System (DNS) and the off-chain domain name includes a Domain Name System (DNS) domain name.

16. The system of claim 10, wherein acquiring the asset identifier for the one or more second systems further comprises:
acquiring an alternative asset identifier for a second system in response to the asset identifier being unavailable on the second system, wherein the alternative asset identifier partially matches the corresponding asset identifier.

17. The system of claim 10, wherein linking the corresponding asset identifier for the first system and the asset identifier for the one or more second systems further comprises:
storing an indication of the asset identifier for the one or more second systems in information associated with the corresponding asset identifier; and
storing an indication of the corresponding asset identifier for the first system in information associated with each asset identifier for the one or more second systems.

18. The system of claim 12, wherein linking the corresponding asset identifier for the first system and the asset identifier for the one or more second systems further comprises:
storing an indication of the on-chain domain name in a Domain Name System (DNS) record for the off-chain domain name; and
conducting a transaction for the on-chain system using the off-chain domain name by retrieving the on-chain domain name from the Domain Name System (DNS) record for the off-chain domain name.

19. A computer program product for accessing an asset of a system, the computer program product comprising one or more computer readable media having instructions stored thereon, the instructions executable by at least one processor to cause the at least one processor to:
acquire an asset identifier for one or more second systems based on a corresponding asset identifier for a first system; and
link the corresponding asset identifier for the first system and the asset identifier for the one or more second systems to enable access of an asset of the corresponding asset identifier on the first system using the asset identifier for the one or more second systems.

20. The computer program product of claim 19, wherein the first system includes an off-chain system and the corresponding asset identifier includes an off-chain domain name, and wherein the one or more second systems each include an on-chain system and the asset identifier includes an on-chain domain name corresponding to the off-chain domain name.

21. The computer program product 20, wherein the on-chain system includes a blockchain and the on-chain domain name includes a blockchain domain name, and wherein the off-chain system includes a Domain Name System (DNS) and the off-chain domain name includes a Domain Name System (DNS) domain name.

22. The computer program product of claim 20, wherein the one or more second systems include a plurality of second systems.

23. The computer program product of claim 19, wherein the first system includes an on-chain system and the corresponding asset identifier includes an on-chain domain name, and wherein a second system includes an off-chain system and the asset identifier includes an off-chain domain name corresponding to the on-chain domain name.

24. The computer program product of claim 23, wherein the on-chain system includes a blockchain and the on-chain domain name includes a blockchain domain name, and wherein the off-chain system includes a Domain Name System (DNS) and the off-chain domain name includes a Domain Name System (DNS) domain name.

25. The computer program product of claim 19, wherein acquiring the asset identifier for the one or more second systems further comprises:
acquiring an alternative asset identifier for a second system in response to the asset identifier being unavailable on the second system, wherein the alternative asset identifier partially matches the corresponding asset identifier.

26. The computer program product of claim 19, wherein linking the corresponding asset identifier for the first system and the asset identifier for the one or more second systems further comprises:
storing an indication of the asset identifier for the one or more second systems in information associated with the corresponding asset identifier; and
storing an indication of the corresponding asset identifier for the first system in information associated with each asset identifier for the one or more second systems.

27. The computer program product of claim 21, wherein linking the corresponding asset identifier for the first system and the asset identifier for the one or more second systems further comprises:
storing an indication of the on-chain domain name in a Domain Name System (DNS) record for the off-chain domain name; and
conducting a transaction for the on-chain system using the off-chain domain name by retrieving the on-chain domain name from the Domain Name System (DNS) record for the off-chain domain name.
